(19) United States
(12) Patent Application Publication
(10) Pub. No.: US 2018/0280892 A1
(43) Pub. Date: Oct. 4, 2018

(54) GAS SEPARATION MEMBRANE, METHOD OF PRODUCING GAS SEPARATION MEMBRANE, GAS SEPARATION MEMBRANE MODULE, AND GAS SEPARATOR

(71) Applicant: FUJIFILM Corporation, Tokyo (JP)

(72) Inventors: Motoi HARADA, Kanagawa (JP); Yusuke MOCHIZUKI, Kanagawa (JP)

(73) Assignee: FUJIFILM Corporation, Tokyo (JP)

(21) Appl. No.: 16/001,946

(22) Filed: Jun. 7, 2018

Related U.S. Application Data
(63) Continuation of application No. PCT/JP2016/087172, filed on Dec. 14, 2016.

(30) Foreign Application Priority Data
Jan. 12, 2016 (JP) 2016-003849

(51) Int. Cl. B01D 69/12; B01D 53/22; B01D 69/02; B01D 71/70; B01D 67/00; C01B 32/50

(52) U.S. Cl. CPC B01D 69/125; B01D 53/228; B01D 69/02; B01D 71/70; C01B 2210/0012; C01B 32/50; B01D 2323/02; B01D 2323/345; B01D 2325/36; B01D 67/0006

(57) ABSTRACT

The gas separation membrane includes a separation layer containing a silsesquioxane compound, and a protective layer, in which a composition of the separation layer in a thickness direction is uniform.

### CROSS-REFERENCE TO RELATED APPLICATIONS

This application is a Continuation of PCT International Application No. PCT/JP2016/87172, filed on Dec. 14, 2016, which claims priority under 35 U.S.C. § 119(a) to Japanese Patent Application No. 2016-3849, filed on Jan. 12, 2016. Each of the above application(s) is hereby expressly incorporated by reference, in its entirety, into the present application.

### BACKGROUND OF THE INVENTION

### 1. Field of the Invention

The present invention relates to a gas separation membrane, a method of producing a gas separation membrane, a gas separation membrane module, and a gas separator.

More specifically, the present invention relates to a gas separation membrane which includes a separation layer containing a silsesquioxane compound and has excellent rub resistance; a method of producing the gas separation membrane; a gas separation membrane module which includes the gas separation membrane; and a gas separator which includes the gas separation membrane module.

### 2. Description of the Related Art

A material formed of a polymer compound has a gas permeability specific to the material. Based on this property, it is possible to cause selective permeation and separation out of a target gas component using a membrane formed of a specific polymer compound (gas separation membrane). As an industrial use aspect for this gas separation membrane related to the problem of global warming, separation and recovery of carbon dioxide from large-scale carbon dioxide sources with this gas separation membrane has been examined in thermal power plants, cement plants, or ironworks blast furnaces. Further, this membrane separation technique has been attracting attention as a means for solving environmental issues which can be achieved with relatively little energy. In addition, the technique is being used as a means for removing carbon dioxide from natural gas mainly including methane and carbon dioxide or biogas (biological excrement, organic fertilizers, biodegradable substances, sewage, garbage, fermented energy crops, or gas generated due to anaerobic digestion).

The following methods are known as a method of securing gas permeability and gas separation selectivity by making a site contributing to gas separation into a thin layer to be used as a practical gas separation membrane. A method of making a portion contributing to gas separation serving as an asymmetric membrane into a thin layer which is referred to as a skin layer, a method of using a thin layer composite membrane (thin film composite) provided with a thin film layer (selective layer) contributing to gas separation which is disposed on a support having mechanical strength, or a method of using hollow fibers including a layer which contributes to gas separation and has high density is known.

As typical performances of a gas separation membrane, gas separation selectivity that enables target gas to be obtained from mixed gas and gas permeability of target gas are exemplified. For the purpose of improving the gas permeability of target gas among those described above, gas separation membranes having various configurations have been examined.

Meanwhile, as a separation membrane that separates gas and non-gas from each other or a separation membrane used for obtaining a target liquid from a mixed liquid, a separation layer containing a silsesquioxane compound has been known (for example, see JP2014-66711A and Chem. Commun., 2015, 51, p. 9932 to 9935).

JP2014-66711A describes a detection device in which a photo-forming membrane is formed of an organosiloxane polymer which is directly photo-formed, and the organosiloxane polymer is substantially permeable to gaseous molecules and impermeable to non-gaseous molecules and ions. Further, JP2014-66711A describes a silsesquioxane polymer as an example of an organosiloxane polymer.

Chem. Commun., 2015, 51, p. 9932 to 9935 describes that water can be selectively separated from a mixture of isopropylalcohol (IPA) and water using high hydrophilicity of a separation layer containing a silsesquioxane compound which has been synthesized according to a photo sol-gel method.

### SUMMARY OF THE INVENTION

As the result of examination conducted by the present inventors on a separation layer that contains a silsesquioxane compound described in Chem. Commun., 2015, 51, p. 9932 to 9935, it was understood that the composition of the layer in the thickness direction is close to uniform so that micro structure control can be performed, and thus this layer can be applied to a gas separation membrane separating gas or the like with a small molecular diameter. Accordingly, application of the separation layer containing a silsesquioxane compound described in these publications to a gas separation membrane has been examined.

However, as the result of examination on gas permeability of the separation layer that contains a silsesquioxane compound described in these publications, the present inventors found that there is a new problem in that the gas permeability is easily degraded even by touching a surface of the separation layer that contains a silsesquioxane compound with a finger.

Similarly, the present inventors found that there is a new problem in that the gas permeability is also degraded due to defects occurring even in a case where the separation layer that contains a silsesquioxane compound of a gas separation membrane rubs against another member such as a holding member in a module during an actual operation even after the gas separation membrane is formed into a module such as a spiral type module.

An object of the present invention is to provide a gas separation membrane which includes a separation layer containing a silsesquioxane compound and has excellent rub resistance.

The present inventors intensively examined the cause of deterioration of rub resistance. As the result, it was understood that the separation layer containing a silsesquioxane compound has a significantly brittle surface compared to other layers having a separation selectivity such as polyimide which have been known in the related art.

As a result of further intensive examination, it was found that, in a case where a protective layer is provided on a surface of the separation layer that contains a silsesquioxane compound, the rub resistance is improved and the separation layer can be sufficiently and practically used as a gas separation membrane.

JP2014-66711A and Chem. Commun., 2015, 51, p. 9932 to 9935 did not pay attention to the fact that the separation layer containing a silsesquioxane compound is brittle, and there is no description or suggestion of using a protective layer. Further, the separation membrane in Chem. Commun., 2015, 51, p. 9932 to 9935 is used for selective separation of water from a mixture of isopropyl alcohol (IPA) and water. However, since the thickness of a layer having a separation selectivity is typically several micrometers or greater in these applications, the separation membrane is not suitable to be used as a gas separation membrane (the thickness thereof is typically 500 nm or less). Therefore, it is difficult for those skilled in the art who have read JP2014-66711A and Chem. Commun., 2015, 51, p. 9932 to 9935 to conceive of the configuration of the gas separation membrane of the present invention.

The present invention and preferred aspects of the present invention as specific means for solving the above-described problems are as follows.

[1] A gas separation membrane comprising: a separation layer which contains a silsesquioxane compound; and a protective layer, in which a composition of the separation layer in a thickness direction is uniform.

[2] The gas separation membrane according to [1], in which a thickness of the protective layer is in a range of 100 to 3500 nm.

[3] The gas separation membrane according to [1] or [2], in which a pure water contact angle in a case where pure water at 25° C. is dropped on a surface of the protective layer is 30 degrees or greater.

[4] The gas separation membrane according to [3], in which the pure water contact angle in a case where pure water at 25° C. is dropped on the surface of the protective layer is 50 degrees or greater.

[5] The gas separation membrane according to [4], in which the pure water contact angle in a case where pure water at 25° C. is dropped on the surface of the protective layer is 90 degrees or greater.

[6] The gas separation membrane according to any one of [1] to [5], in which the protective layer contains a silicone resin.

[7] The gas separation membrane according to any one of [1] to [6], in which the gas separation membrane allows selective permeation of carbon dioxide from mixed gas containing carbon dioxide and gas other than carbon dioxide.

[8] The gas separation membrane according to any one of [1] to [7], further comprising: a support which is provided on a side of the separation layer opposite to the protective layer.

[9] A method of producing a gas separation membrane according to any one of [1] to [8], comprising: a step of forming a film by carrying out reaction of the separation layer using a sol-gel method to synthesize the silsesquioxane compound.

[10] The method of producing a gas separation membrane according to [9], in which the reaction carried out using the sol-gel method is initiated or promoted by photo-excitation.

[11] A gas separation membrane module comprising: the gas separation membrane according to any one of [1] to [8].

[12] A gas separator comprising: the gas separation membrane module according to [11].

In the present specification, when a plurality of substituents or linking groups (hereinafter, referred to as substituents or the like) shown by specific symbols are present or a plurality of substituents are defined simultaneously or alternatively, this means that the respective substituents may be the same as or different from each other. In addition, even in a case where not specifically stated, when a plurality of substituents or the like are adjacent to each other, they may be condensed or linked to each other and form a ring.

In regard to compounds (including resins) described in the present specification, the description includes salts thereof and ions thereof in addition to the compounds. Further, the description includes derivatives formed by changing a predetermined part within the range in which desired effects are exhibited.

A substituent (the same applies to a linking group) in the present specification may include an optional substituent of the group within the range in which desired effects are exhibited. The same applies to a compound in which substitution or non-substitution is not specified.

According to the present invention, it is possible to provide a gas separation membrane which includes a separation layer containing a silsesquioxane compound and has excellent rub resistance.

### BRIEF DESCRIPTION OF THE DRAWINGS

FIG. 1 is a view schematically illustrating an example of a gas separation membrane of the present invention.

FIG. 2 is a view schematically illustrating another example of a gas separation membrane of the present invention.

FIG. 3 is a view schematically illustrating an example of a protective layer and a porous layer used for the gas separation membrane of the present invention.

FIG. 4 is a view for schematically describing a position of a surface of a separation layer that contains a silsesquioxane compound at a depth d (in direction of support) from a front surface of the separation layer that contains a silsesquioxane compound and a position of the front surface of the separation layer that contains a silsesquioxane compound in an example of the gas separation membrane of the present invention.

### DESCRIPTION OF THE PREFERRED EMBODIMENTS

Hereinafter, the present invention will be described in detail. The description of constituent elements described below is occasionally made based on the exemplary embodiments of the present invention, but the present invention is not limited to such embodiments. In addition, the numerical ranges shown using “to” in the present specification indicate ranges including the numerical values described before and after “to” as the lower limits and the upper limits.

[Gas Separation Membrane]

A gas separation membrane of the present invention is a gas separation membrane which includes a separation layer containing a silsesquioxane compound and a protective layer, in which the composition of the separation layer in the thickness direction is uniform.

With such a configuration, the gas separation membrane of the present invention includes a separation layer containing a silsesquioxane compound, and the rub resistance thereof is excellent. In a case where a protective layer is provided, deterioration caused by unintentional contact between the separation layer that contains a silsesquioxane compound and another material at the time of using a module after being formed from the gas separation membrane can be suppressed so that the rub resistance can be improved.

Further, according to a preferred aspect of the gas separation membrane of the present invention, it is preferable that initial gas separation performance thereof is also high. In the related art, it was predicted that the gas permeability is decreased by employing a laminated structure as described in “Advances in Barrier Technologies—Current Situations and Developments of Barrier film, Barrier Container, Sealing agent, and Sealing material—(Chapter 1, p. 2, Yuichi Hirata, p. 3, Kenji Kano)” in a case where a protective layer is provided for a separation membrane. On the contrary, according to the preferred aspect of the present invention, the present invention is preferable in terms that deterioration of the separation layer during a film forming process performed by a typical producing device is suppressed by providing a protective layer for the separation layer and initial gas separation performance (initial performance) is also improved even in a case where a protective layer is not provided. It is considered that unintentional contact between the separation layer that contains a silsesquioxane compound and another material in a step of winding the gas separation membrane around a roll or at the time of handling can be prevented by providing a protective layer for the formed separation layer that contains a silsesquioxane compound. It has not been known that the separation layer containing a silsesquioxane compound is so brittle that the separation layer deteriorates during the film forming process performed by a typical producing device. Therefore, the effect of improving the initial gas separation performance (initial performance) is an effect which cannot be predicted by those skilled in the art.

According to another preferred aspect of the gas separation membrane of the present invention, it is preferable that the gas separation membrane also has water resistance. The separation layer containing a silsesquioxane compound is a membrane having high hydrophilicity as described in Chem. Commun., 2015, 51, p. 9932 to 9935. Consequently, the gas permeability is deteriorated over time because of the influence of the separation layer, assumed to absorb water at the time of being used as a gas separation membrane in some cases. On the contrary, according to the preferred aspect of the present invention, the present invention is preferable in terms that deterioration of gas permeability over time is suppressed by providing, as a protective layer, a hydrophobic protective layer with a high pure water contact angle described below. In Chem. Commun., 2015, 51, p. 9932 to 9935, the permeability of water is increased by using the hydrophilicity of the separation layer that contains a silsesquioxane compound to separate water from isopropanol. The effect of suppressing deterioration of gas permeability over time by providing a hydrophobic protective layer for a separation layer that contains a silsesquioxane compound is an effect which cannot be predicted by those skilled in the art.

In the present specification, the separation layer indicates a layer having a separation selectivity. A layer having a separation selectivity indicates a layer in which a ratio (PCO₂/PCH₄) of a permeability coefficient (PCO₂) of carbon dioxide to a permeability coefficient (PCH₄) of methane, in a case where a membrane having a thickness of 0.05 to 30 μm is formed and pure gas of carbon dioxide (CO₂) and methane (CH₄) is supplied to the obtained membrane at a temperature of 40° C. by setting the total pressure of the gas supply side to 0.5 MPa, is 1.5 or greater.

It is preferable that the gas separation membrane of the present invention is produced according a method of producing a gas separation membrane of the present invention described below. The mechanism of the performance of the gas separation membrane is considered to be determined according to the size of holes in the plane of a layer contributing to gas separation, but the operation of specifying the size of holes takes time and cost even in case where an electron microscope is used. Further, the operation of specifying the structure of the separation layer that contains a silsesquioxane compound produced by synthesizing a silsesquioxane compound through the reaction carried out according to a sol-gel method described below takes time or cost even in a case where an electron microscope is used. Therefore, it is technically impossible or impractical to specify all the features of preferred aspects of the gas separation membrane of the present invention as the structures of the object, at the time of filing the present invention.

Hereinafter, preferred embodiments of the gas separation membrane of the present invention will be described.

<Configuration>

It is preferable that the gas separation membrane of the present invention is a thin layer composite membrane (also referred to as a gas separation composite membrane) or an asymmetric membrane or is formed of hollow fibers. Among these, a thin layer composite membrane is more preferable.

Hereinafter, a case where the gas separation membrane is a thin layer composite membrane will be described as a typical example, but the gas separation membrane of the present invention is not limited to this thin layer composite membrane.

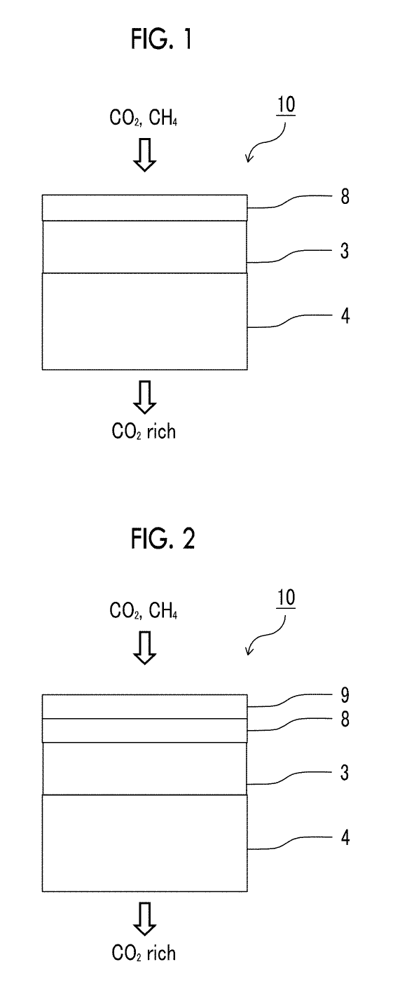

A preferred configuration of the gas separation membrane of the present invention will be described with reference to the accompanying drawings. An example of a gas separation membrane 10 of the present invention illustrated in FIG. 1 is a thin layer composite membrane and the gas separation membrane 10 includes a support 4, a separation layer 3 that contains a silsesquioxane compound, and a protective layer 8 in this order.

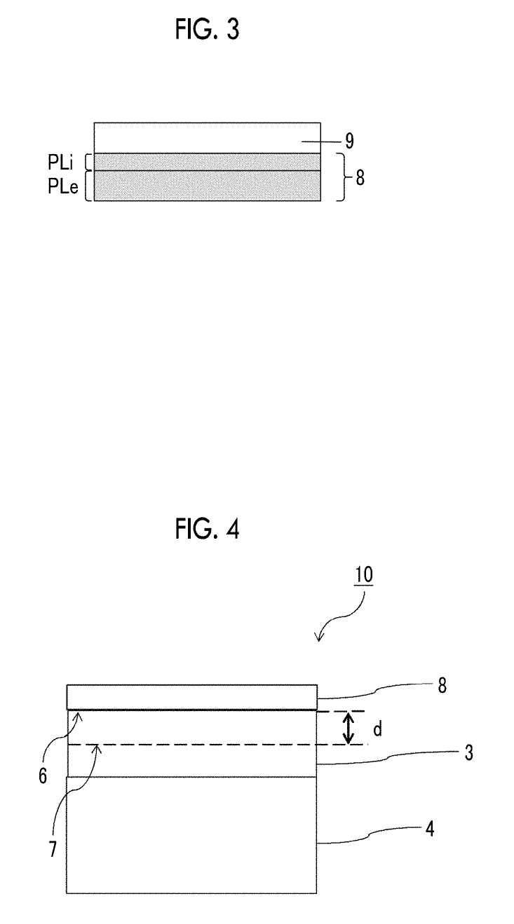

Another example of the gas separation membrane 10 of the present invention illustrated in FIG. 2 is the gas separation membrane 10 including the support 4, the separation layer 3 that contains a silsesquioxane compound, the protective layer 8, and a porous layer 9 in this order. FIG. 3 is a view schematically illustrating an example of a protective layer and a porous layer used for the gas separation membrane of the present invention. As illustrated in FIG. 3, it is preferable that the protective layer 8 is adjacent to the porous layer 9 (a portion which is not filled with the protective layer). As illustrated in FIG. 3, it is preferable that the protective layer 8 includes a region PLi present in the porous layer (the porous layer before permeation of the protective layer is formally referred to as a porous layer b) and a region PLe present below the porous layer (porous layer b).

The gas separation membrane of the present invention may have only one or two or more separation layers containing a silsesquioxane compound. The gas separation membrane of the present invention has preferably one to five separation layers containing a silsesquioxane compound, more preferably one to three separation layers, particularly preferably one or two separation layers, and more particularly preferably only one separation layer from the viewpoint of production cost.

The expression “on the support” in the present specification means that another layer may be interposed between the support and a layer having separation selectivity. Further, in regard to the expressions related to up and down, the direction in which a gas to be separated is supplied to is set as “up” and the direction in which the separated gas is discharged is set as “down” as illustrated in FIG. 1 unless otherwise specified.

In FIG. 4, the surface of the separation layer 3 containing a silsesquioxane compound is denoted by the reference numeral 6. An O/Si ratio (surface) which is the ratio of the number of oxygen atoms to the number of silicon atoms in the surface of the separation layer that contains a silsesquioxane compound indicates an O/Si ratio which is the ratio of the number of oxygen atoms to the number of silicon atoms in the surface 6 of the separation layer that contains a silsesquioxane compound.

Further, in FIG. 4, in a case where the depth d is 45 nm, the surface parallel with the “surface 6 of the separation layer containing a silsesquioxane compound” at a depth of 45 nm (in the direction of a support) from the surface of the separation layer 3 containing a silsesquioxane compound is a “surface of a separation layer containing a silsesquioxane compound at a depth d (in the direction of the support) from the surface of the separation layer containing a silsesquioxane compound” which is represented by the reference numeral 7. An O/Si ratio (45 nm) which is the ratio of the number of oxygen atoms to the number of silicon atoms contained in the separation layer that contains a silsesquioxane compound at a depth of 45 nm from the surface of the separation layer that contains a silsesquioxane compound indicates an O/Si ratio which is the ratio of the number of oxygen atoms to the number of silicon atoms in a “surface 7 of the separation layer containing a silsesquioxane compound at a depth d (in the direction of the support) from the surface of the separation layer containing a silsesquioxane compound”.

<Support>

It is preferable that the gas separation membrane of the present invention includes a support on a side of the separation layer opposite to the protective layer and more preferable that the separation layer containing a silsesquioxane compound is formed on the support. From the viewpoint of ensuring the gas permeability sufficiently, it is preferable that the support is thin and is formed of a porous material.

The gas separation membrane of the present invention may be obtained by forming and disposing the separation layer 3 containing a silsesquioxane compound on or in the surface of the porous support or may be a thin layer composite membrane conveniently obtained by forming the separation layer on the surface thereof. In a case where the separation layer 3 containing a silsesquioxane compound is formed on the surface of the porous support, a gas separation membrane with an advantage of having high gas separation selectivity, high gas permeability, and mechanical strength at the same time can be obtained.

In a case where the gas separation membrane of the present invention is a thin layer composite membrane, it is preferable that the thin layer composite membrane is formed by coating the surface of the porous support with a coating solution (dope) that forms the separation layer 3 that contains a silsesquioxane compound described above. Further, the term “coating” in the present specification includes a form made by a coating material being adhered to a surface through immersion. Specifically, it is preferable that the support has a porous layer on the separation layer 3 side that contains a silsesquioxane compound and more preferable that the support is a laminate of non-woven fabric and a porous layer disposed on the separation layer 3 side that contains a silsesquioxane compound.

The material of the porous layer which is preferably applied to the support is not particularly limited and may be an organic or inorganic material as long as the material satisfies the purpose of providing mechanical strength and high gas permeability. A porous membrane of an organic polymer is preferable, and the thickness thereof is preferably in a range of 1 to 3,000 μm, more preferably in a range of 5 to 500 μm, and still more preferably in a range of 5 to 150 μm. In regard to the pore structure of the porous layer, the average pore diameter thereof is typically 10 μm or less, preferably 0.5 μm or less, and more preferably 0.2 μm or less. The porosity thereof is preferably in a range of 20% to 90% and more preferably in a range of 30% to 80%. Further, the molecular weight cut-off of the porous layer is preferably 100,000 or less. Moreover, the gas permeability is preferably 3×10⁻⁵ cm³ (STP)/cm²·cm·sec·cmHg (30 GPU) or greater in terms of the permeation rate of carbon dioxide. Further, STP is an abbreviation standing for standard temperature and pressure. Further, GPU is an abbreviation standing for gas permeation unit.

Examples of the material of the porous layer include conventionally known polymers, for example, various resins such as a polyolefin resin such as polyethylene or polypropylene; a fluorine-containing resin such as polytetrafluoroethylene, polyvinyl fluoride, or polyvinylidene fluoride; polystyrene, cellulose acetate, polyurethane, polyacrylonitrile, polyphenylene oxide, polysulfone, polyether sulfone, polyimide, polyaramid, and polyethylene terephthalate. As the shape of the porous layer, any of a flat shape, a spiral shape, a tubular shape, and a hallow fiber shape can be employed.

According to the preferred aspect of the present invention, it is preferable that the separation layer containing a silsesquioxane compound is formed by synthesizing the silsesquioxane compound through the reaction carried out according to a sol-gel method. Further, it is preferable that the reaction carried out according to the sol-gel method is initiated or promoted by photo-excitation. The membrane formed by using the reaction carried out according to the sol-gel method which is initiated or promoted by photo-excitation can be formed into the separation layer containing a silsesquioxane compound at a low temperature. Therefore, according to the preferred aspect of the present invention, a material with low heat resistance such as an organic support can also be used as the material of the support or the porous layer applied to the support. In other words, the preferred aspect of the present invention relates to a gas separation membrane obtained by using a material with low heat resistance as the material of the support.

Examples of the material with low heat resistance used for the support include polyethylene terephthalate, polyethylene, polyacrylonitrile, and methyl polymethacrylate.

In the thin layer composite membrane, it is preferable that woven fabric, non-woven fabric, or a net used to provide mechanical strength is provided in the lower portion of the porous layer disposed on the side of the separation layer 3 containing a silsesquioxane compound. In terms of film forming properties and the cost, non-woven fabric is suitably used. As the non-woven fabric, fibers formed of polyester, polypropylene, polyacrylonitrile, polyethylene, and polyamide may be used alone or in combination of plural kinds thereof. The non-woven fabric can be produced by papermaking main fibers and binder fibers which are uniformly dispersed in water using a circular net or a long net and then drying the fibers with a drier. Moreover, for the purpose of removing a nap or improving mechanical properties, it is preferable that thermal pressing processing is performed on the non-woven fabric by interposing the non-woven fabric between two rolls.

<Separation Layer Containing Silsesquioxane Compound>

The gas separation membrane of the present invention includes a separation layer containing a silsesquioxane compound, and the composition of the separation layer in the thickness direction is uniform.

The “silsesquioxane” is a general term for polysiloxane having a basic constitutional unit of “RSiO_{3/2}”. Further, R in the formula represents an organic functional group bonded to a silicon atom. The basic constitutional unit is represented by RSiO_{3/2} since a silicon atom in silsesquioxane is bonded to three oxygen atoms and an oxygen atom is bonded to two silicon atoms. The Latin word “sesqui” indicating two-thirds is used here.

The expression “the composition of the separation layer in the thickness direction is uniform” means that variation in composition of the separation layer in the thickness direction is 10% or less.

The variation in composition of the separation layer in the thickness direction is acquired as a percentage by dividing a difference between the maximum value and the minimum value among the O/Si ratio of the composition in one surface of the separation layer, the O/Si ratio of the composition in a central portion of the separation layer in the thickness direction, and the O/Si ratio of the composition in the other surface of the separation layer by the average value of these 0/Si ratios.

For example, in a case where the thickness of the separation layer is 90 nm, the variation in composition of the separation layer in the thickness direction is acquired as a percentage by dividing a difference between the maximum value and the minimum value among the O/Si ratio (surface), the O/Si ratio (45 nm), and the O/Si ratio (90 nm) by the average value of the O/Si ratio (surface), the O/Si ratio (45 nm), and the O/Si ratio (90 nm). The O/Si ratio (45 nm) which is the ratio of the number of oxygen atoms to the number of silicon atoms contained in the separation layer containing a silsesquioxane compound at a depth of 45 nm from the surface of the separation layer containing a silsesquioxane compound, the O/Si ratio (surface) which is the ratio of the number of oxygen atoms to the number of silicon atoms in the surface of the separation layer containing a silsesquioxane compound, and the O/Si ratio (90 nm) which is the ratio of the number of oxygen atoms to the number of silicon atoms of the separation layer containing a silsesquioxane compound at a depth of 90 nm from the surface of the separation layer containing a silsesquioxane compound are also acquired according to the following method.

The variation in composition of the separation layer in the thickness direction is preferably 5% or less and more preferably 3% or less.

The above-described separation layer containing a silsesquioxane compound contains a silsesquioxane compound. It is preferable that the silsesquioxane compound is synthesized by the reaction carried out according to a sol-gel method and more preferable that the silsesquioxane compound is a sol-gel cured product obtained by hydrolysis and polycondensation. From the viewpoint of carrying out the reaction at a low temperature according to a sol-gel method, it is preferable that the reaction carried out according to the sol-gel method is initiated or promoted by photo-excitation.

It is preferable that the silsesquioxane compound synthesized by the reaction carried out according to the sol-gel method which is initiated or promoted by photo-excitation is synthesized using the materials described in Chem. Commun., 2015, 51, p. 9932 to 9935, and the contents of these publications are incorporated herein by reference.

It is preferable that the silsesquioxane compound is synthesized using alkoxysilane containing one or more radical polymerizable functional groups as a material.

As the radical polymerizable functional group contained in alkoxysilane containing one or more radical polymerizable functional groups, an acryloyl group or a methacryloyl group is preferable.

The number of radical polymerizable functional groups contained in alkoxysilane containing one or more radical polymerizable functional groups is preferably in a range of 1 to 3 and more preferable 1 or 2.

As the alkoxy group contained in alkoxysilane containing one or more radical polymerizable functional groups, an alkoxy group having 1 to 3 carbon atoms is preferable, a methoxy group or an ethoxy group is more preferable, and a methoxy group is particularly preferable.

Specific examples of the alkoxysilane containing one or more radical polymerizable functional groups include 3-methacryloxypropyltrimethoxysilane and 3-acryloxypropyltrimethoxysilane.

The silsesquioxane compound may be synthesized using alkoxysilane that does not contain a radical polymerizable functional group as a material. Specific examples of the alkoxysilane that does not contain a radical polymerizable functional group include 1,2-bis(trimethoxysilyl)ethane, phenyltrimethoxysilane, hexyltrimethoxysilane, and trifluoropropyltrimethoxysilane.

Further, in a case where a silsesquioxane compound is synthesized through the reaction carried out according to a sol-gel method which is initiated or promoted by photo-excitation, a known additive can be used.

In a case where a silsesquioxane compound is synthesized through the reaction carried out according to a sol-gel method which is initiated or promoted by photo-excitation, it is preferable that a known photopolymerization initiator and a known radical polymerization initiator are used as the materials of the separation layer that contains a silsesquioxane compound.

Further, it is preferable that a combination of a solvent, a polymerization inhibitor, an acid (for example, acetic acid), and the like is added.

The proportions of alkoxysilane and each additive are not particularly limited. For example, the following proportions are preferable.

The content of the alkoxysilane is in a range of 1% to 20%, the content of the photopolymerization initiator is in a range of 0.01% to 5%, the content of the radical polymerization initiator is in a range of 0.01% to 5%, the content of the solvent is in a range of 50% to 95%, the content of the polymerization inhibitor is in a range of 0.01% to 5%, and the content of acetic acid in a case of using acetic acid as an acid is in a range of 0.1% to 5%.

It is preferable that the material of the separation layer containing a silsesquioxane compound is prepared as the composition that contains an organic solvent at the time of formation of the separation layer containing a silsesquioxane compound to form a separation layer precursor that contains a silsesquioxane compound. It is preferable that the composition for forming the separation layer precursor that contains a silsesquioxane compound is prepared as the composition which can react according to a sol-gel method. The solvent used for forming the separation layer that contains a silsesquioxane compound is not particularly limited, and examples thereof include n-heptane, acetic acid, water, n-hexane, 2-butanone, methanol, ethanol, isopropyl alcohol, cyclohexanone, acetone, and dimethyl sulfoxide (DMSO).

(Characteristics)

The film thickness of the separation layer containing a silsesquioxane compound is not particularly limited.

The film thickness of the separation layer containing a silsesquioxane compound is preferably in a range of 30 to 500 nm from the viewpoints of forming a membrane without defects and increasing the permeability, more preferably in a range of 30 to 200 nm, and particularly preferably in a range of 30 to 100 nm. The film thickness of the separation layer containing a silsesquioxane compound can be acquired using a scanning electron microscope (SEM).

The film thickness of the separation layer containing a silsesquioxane compound can be controlled by adjusting the coating amount of the composition used for forming the separation layer precursor containing a silsesquioxane compound.

Other preferable characteristics of the separation layer containing a silsesquioxane compound are as follows.

In a case where heating is performed during the hydrolysis and the polycondensation reaction of alkoxysilane, from the viewpoint of using a support at a low cost and with low heat resistance, the reaction temperature is preferably 100° C. or lower and particularly preferably 90° C. or less.

<Additional Resin Layer>

The gas separation membrane of the present invention may contain an additional resin layer other than the separation layer containing a silsesquioxane compound and the protective layer (hereinafter, referred to as an additional resin layer).

Examples of the resin contained in the additional resin layer are described below, but are not limited thereto. Specifically, the compound having a siloxane bond, polyimides, polyamides, celluloses, polyethylene glycols, and polybenzoxazoles are preferable and at least one selected from the compound having a siloxane bond, polyimide, polybenzoxazole, and acetic acid cellulose is more preferable. It is particularly preferable that the gas separation membrane of the present invention includes the separation layer containing a silsesquioxane compound and further includes a layer containing polyimide as the additional resin layer.

Polyimide having a reactive group is preferable as polyimide.

Hereinafter, a case where the resin of the additional resin layer is polyimide having a reactive group will be described as a typical example, but the present invention is not limited to the case where a polymer having a reactive group is polyimide having a reactive group.

The polyimide having a reactive group which can be used in the present invention will be described below in detail.

According to the present invention, in polyimide having a reactive group, it is preferable that a polymer having a reactive group includes a polyimide unit and a repeating unit having a reactive group (preferably a nucleophilic reactive group and more preferably a carboxyl group, an amino group, or a hydroxyl group) on the side chain thereof.

More specifically, it is preferable that the polymer having a reactive group includes at least one repeating unit represented by the following Formula (I) and at least one repeating unit represented by the following Formula (III-a) or (III-b).

Further, it is more preferable that the polymer having a reactive group includes at least one repeating unit represented by the following Formula (I), at least one repeating unit represented by the following Formula (II-a) or (II-b), and at least one repeating unit represented by the following Formula (III-a) or (III-b).

The polyimide having a reactive group which can be used in the present invention may include repeating units other than the respective repeating units described above, and the number of moles thereof is preferably 20 or less and more preferably in a range of 0 to 10 when the total number of moles of the respective repeating units represented by each of Formulae is set to 100. It is particularly preferable that the polyimide having a reactive group which can be used in the present invention is formed of only the respective repeating units represented by each of the following formulae.

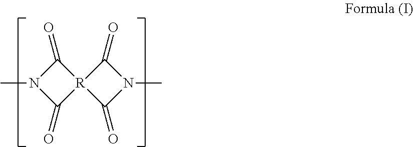

In Formula (I), R represents a group having a structure represented by any of the following Formulae (I-a) to (I-h). In the following Formulae (I-a) to (I-h), the symbol “*” represents a binding site with respect to a carbonyl group of Formula (I). R in Formula (I) is occasionally referred to as a mother nucleus. It is preferable that this mother nucleus R is a group represented by Formula (I-a), (I-b), or (I-d), more preferable that this mother nucleus R is a group represented by Formula (I-a) or (I-d), and particularly preferable that this mother nucleus R is a group represented by Formula (I-a).

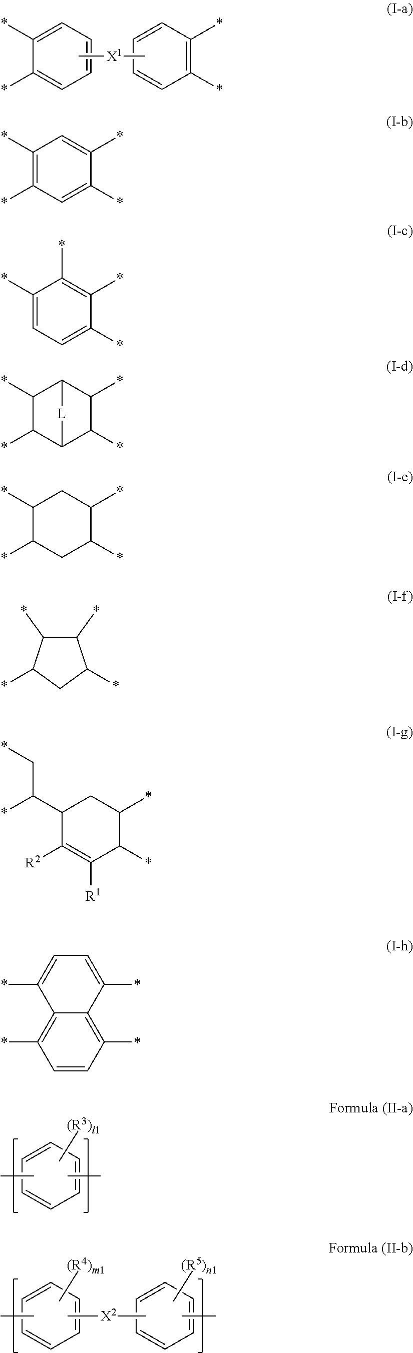

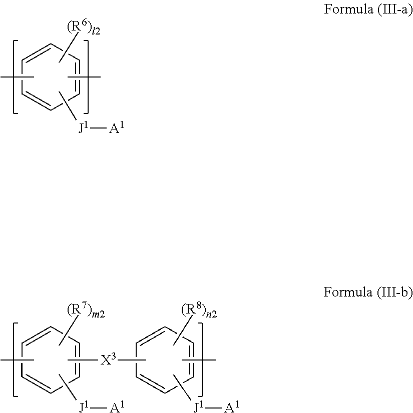

X¹, X², and X³

X¹, X², and X³ represent a single bond or a divalent linking group. As the divalent linking groups of these, —C(R^{x})₂— (R^{x} represents a hydrogen atom or a substituent. In a case where R^{x} represents a substituent, R^{x}'s may be linked to each other and form a ring), —O—, —SO₂—, —C(═O)—, —S—, —NR^{Y}— (R^{Y} represents a hydrogen atom, an alkyl group (preferably a methyl group or an ethyl group), or an aryl group (preferably a phenyl group)), or a combination of these is preferable and a single bond or —C(R^{x})₂— is more preferable. When R′ represents a substituent, a substituent group Z described below is specifically exemplified. Among these, an alkyl group is preferable, an alkyl group having a halogen atom as a substituent is more preferable, and trifluoromethyl is particularly preferable. Further, in regard to the expression “may be linked to each other and form a ring” in the present specification, the linkage may be made by a single bond or a double bond and then a cyclic structure may be formed or condensation may be made and then a condensed ring structure may be formed.

L

L represents —CH₂═CH₂— or —CH₂— and —CH₂═CH₂— is preferable.

R¹ and R²

R¹ and R² represent a hydrogen atom or a substituent. As the substituent, any one selected from the substituent group Z described below can be used. R¹ and R² may be bonded to each other and form a ring.

R¹ and R² represent preferably a hydrogen atom or an alkyl group, more preferably a hydrogen atom, a methyl group, or an ethyl group, and still more preferably a hydrogen atom.

R³

R³ represents an alkyl group or a halogen atom. The preferable ranges of the alkyl group and the halogen atom are the same as those of an alkyl group and a halogen atom defined in the substituent group Z described below. l1 showing the number of R³'s represents an integer of 0 to 4, is preferably in a range of 1 to 4, and is more preferably 3 or 4. It is preferable that R³ represents an alkyl group and more preferable that R³ represents a methyl group or an ethyl group.

R⁴ and R⁵

R⁴ and R⁵ represent an alkyl group or a halogen atom or a group in which R⁴ and R⁵ are linked to each other and form a ring together with X². The preferable ranges of the alkyl group and the halogen atom are the same as those of an alkyl group and a halogen atom defined in the substituent group Z described below. The structure formed by R⁴ and R⁵ being linked to each other is not particularly limited, but it is preferable that the structure is a single bond, —O—, or —S—. m1 and n1 respectively showing the numbers of R⁴'s and R⁵'s represent an integer of 0 to 4, are preferably in a range of 1 to 4, and are more preferably 3 or 4.

In a case where R⁴ and R⁵ represent an alkyl group, it is preferable that R⁴ and R⁵ represent a methyl group or an ethyl group and also preferable that R⁴ and R⁵ represent trifluoromethyl.

R⁶, R⁷, and R⁸

R⁶, R⁷, and R⁸ represent a substituent. Here, R⁷ and R⁸ may be bonded to each other and form a ring. l2, m2, and n2 respectively showing the numbers of these substituents represent an integer of 0 to 4, are preferably in a range of 0 to 2, and are more preferably 0 or 1.

J¹

J¹ represents a single bond or a divalent linking group. As the linking group, *—COO⁻N⁺R^{b}R^{c}R^{d}—** (R^{b} to R^{d} represent a hydrogen atom, an alkyl group, or an aryl group, and preferable ranges thereof are respectively the same as those described in the substituent group Z described below), *—SO₃⁻N⁺R^{e}R^{f}R^{g}—** (R^{e} to R^{g} represent a hydrogen atom, an alkyl group, or an aryl group, and preferable ranges thereof are respectively the same as those described in the substituent group Z described below), an alkylene group, or an arylene group is exemplified. The symbol “*” represents a binding site on the phenylene group side and the symbol “**” represents a binding site on the opposite side of the phenylene group. It is preferable that J¹ represents a single bond, a methylene group, or a phenylene group and a single bond is particularly preferable.

A¹

A¹ is not particularly limited as long as A¹ represents a group in which a crosslinking reaction may occur, but it is preferable that A¹ represents a nucleophilic reactive group and more preferable that A¹ represents a group selected from a carboxyl group, an amino group, a hydroxyl group, and —S(═O)₂OH. The preferable range of the amino group is the same as the preferable range of the amino group described in the substituent group Z below. A′ represents still more preferably a carboxyl group, an amino group, or a hydroxyl group, particularly preferably a carboxyl group or a hydroxyl group, and most preferably a carboxyl group.

Examples of the substituent group Z include:

an alkyl group (the number of carbon atoms of the alkyl group is preferably in a range of 1 to 30, more preferably in a range of 1 to 20, and particularly preferably in a range of 1 to 10, and examples thereof include methyl, ethyl, iso-propyl, tert-butyl, n-octyl, n-decyl, and n-hexadecyl), a cycloalkyl group (the number of carbon atoms of the cycloalkyl group is preferably in a range of 3 to 30, more preferably in a range of 3 to 20, and particularly preferably in a range of 3 to 10, and examples thereof include cyclopropyl, cyclopentyl, and cyclohexyl), an alkenyl group (the number of carbon atoms of the alkenyl group is preferably in a range of 2 to 30, more preferably in a range of 2 to 20, and particularly preferably in a range of 2 to 10, and examples thereof include vinyl, allyl, 2-butenyl, and 3-pentenyl), an alkynyl group (the number of carbon atoms of the alkynyl group is preferably in a range of 2 to 30, more preferably in a range of 2 to 20, and particularly preferably in a range of 2 to 10, and examples thereof include propargyl and 3-pentynyl), an aryl group (the number of carbon atoms of the aryl group is preferably in a range of 6 to 30, more preferably in a range of 6 to 20, and particularly preferably in a range of 6 to 12, and examples thereof include phenyl, para-methylphenyl, naphthyl, and anthranyl), an amino group (such as an amino group, an alkylamino group, an arylamino group, or a heterocyclic amino group; the number of carbon atoms of the amino group is preferably in a range of 0 to 30, more preferably in a range of 0 to 20, and particularly preferably in a range of 0 to 10 and examples thereof include amino, methylamino, dimethylamino, diethylamino, dibenzylamino, diphenylamino, and ditolylamino), an alkoxy group (the number of carbon atoms of the alkoxy group is preferably in a range of 1 to 30, more preferably in a range of 1 to 20, and particularly preferably in a range of 1 to 10, and examples thereof include methoxy, ethoxy, butoxy, and 2-ethylhexyloxy), an aryloxy group (the number of carbon atoms of the aryloxy group is preferably in a range of 6 to 30, more preferably in a range of 6 to 20, and particularly preferably in a range of 6 to 12, and examples thereof include phenyloxy, 1-naphthyloxy, and 2-naphthyloxy), a heterocyclic oxy group (the number of carbon atoms of the heterocyclic oxy group is preferably in a range of 1 to 30, more preferably in a range of 1 to 20, and particularly preferably in a range of 1 to 12, and examples thereof include pyridyloxy, pyrazyloxy, pyrimidyloxy, and quinolyloxy),

an acyl group (the number of carbon atoms of the acyl group is preferably in a range of 1 to 30, more preferably in a range of 1 to 20, and particularly preferably in a range of 1 to 12, and examples thereof include acetyl, benzoyl, formyl, and pivaloyl), an alkoxycarbonyl group (the number of carbon atoms of the alkoxycarbonyl group is preferably in a range of 2 to 30, more preferably in a range of 2 to 20, and particularly preferably in a range of 2 to 12, and examples thereof include methoxycarbonyl and ethoxycarbonyl), an aryloxycarbonyl group (the number of carbon atoms of the aryloxycarbonyl group is preferably in a range of 7 to 30, more preferably in a range of 7 to 20, and particularly preferably in a range of 7 to 12, and examples thereof include phenyloxycarbonyl), an acyloxy group (the number of carbon atoms of the acyloxy group is preferably in a range of 2 to 30, more preferably in a range of 2 to 20, and particularly preferably in a range of 2 to 10, and examples thereof include acetoxy and benzoyloxy), an acylamino group (the number of carbon atoms of the acylamino group is preferably in a range of 2 to 30, more preferably in a range of 2 to 20, and particularly preferably in a range of 2 to 10, and examples thereof include acetylamino and benzoylamino),

an alkoxycarbonylamino group (the number of carbon atoms of the alkoxycarbonylamino group is preferably in a range of 2 to 30, more preferably in a range of 2 to 20, and particularly preferably in a range of 2 to 12, and examples thereof include methoxycarbonylamino), an aryloxycarbonylamino group (the number of carbon atoms of the aryloxycarbonylamino group is preferably in a range of 7 to 30, more preferably in a range of 7 to 20, and particularly preferably in a range of 7 to 12, and examples thereof include phenyloxycarbonylamino), a sulfonylamino group (the number of carbon atoms of the sulfonylamino group is preferably in a range of 1 to 30, more preferably in a range of 1 to 20, and particularly preferably in a range of 1 to 12, and examples thereof include methanesulfonylamino and benzenesulfonylamino), a sulfamoyl group (the number of carbon atoms of the sulfamoyl group is preferably in a range of 0 to 30, more preferably in a range of 0 to 20, and particularly preferably in a range of 0 to 12, and examples thereof include sulfamoyl, methylsulfamoyl, dimethylsulfamoyl, and phenylsulfamoyl),

a carbamoyl group (the number of carbon atoms of the carbamoyl group is preferably in a range of 1 to 30, more preferably in a range of 1 to 20, and particularly preferably in a range of 1 to 12, and examples thereof include carbamoyl, methyl carbamoyl, diethyl carbamoyl, and phenyl carbamoyl), an alkylthio group (the number of carbon atoms of the alkylthio group is preferably in a range of 1 to 30, more preferably in a range of 1 to 20, and particularly preferably in a range of 1 to 12, and examples thereof include methylthio and ethylthio), an arylthio group (the number of carbon atoms of the arylthio group is preferably in a range of 6 to 30, more preferably in a range of 6 to 20, and particularly preferably in a range of 6 to 12, and examples thereof include phenylthio), a heterocyclic thio group (the number of carbon atoms of the heterocyclic thio group is preferably in a range of 1 to 30, more preferably in a range of 1 to 20, and particularly preferably in a range of 1 to 12, and examples thereof include pyridylthio, 2-benzimidazolylthio, 2-benzoxazolylthio, and 2-benzothiazolylthio),

a sulfonyl group (the number of carbon atoms of the sulfonyl group is preferably in a range of 1 to 30, more preferably in a range of 1 to 20, and particularly preferably in a range of 1 to 12, and examples thereof include mesyl and tosyl), a sulfinyl group (the number of carbon atoms of the sulfinyl group is preferably in a range of 1 to 30, more preferably in a range of 1 to 20, and particularly preferably in a range of 1 to 12, and examples thereof include methanesulfinyl and benzenesulfinyl), an ureido group (the number of carbon atoms of the ureido group is preferably in a range of 1 to 30, more preferably in a range of 1 to 20, and particularly preferably in a range of 1 to 12, and examples thereof include ureido, methylureido, and phenylureido), a phosphoric acid amide group (the number of carbon atoms of the phosphoric acid amide group is preferably in a range of 1 to 30, more preferably in a range of 1 to 20, and particularly preferably in a range of 1 to 12, and examples thereof include diethyl phosphoric acid amide and phenyl phosphoric acid amide), a hydroxyl group, a mercapto group, a halogen atom (such as a fluorine atom, a chlorine atom, a bromine atom, or an iodine atom, and a fluorine atom is more preferable),

a cyano group, a sulfo group, a carboxyl group, an oxo group, a nitro group, a hydroxamic acid group, a sulfino group, a hydrazino group, an imino group, a heterocyclic group (a 3- to 7-membered ring heterocyclic group is preferable, the hetero ring may be aromatic or non-aromatic, examples of a heteroatom constituting the hetero ring include a nitrogen atom, an oxygen atom, and a sulfur atom, the number of carbon atoms of the heterocyclic group is preferably in a range of 0 to 30 and more preferably in a range of 1 to 12, and specific examples thereof include imidazolyl, pyridyl, quinolyl, furyl, thienyl, piperidyl, morpholino, benzoxazolyl, benzimidazolyl, benzothiazolyl, carbazolyl, and azepinyl), a silyl group (the number of carbon atoms of the silyl group is preferably in a range of 3 to 40, more preferably in a range of 3 to 30, and particularly preferably in a range of 3 to 24, and examples thereof include trimethylsilyl and triphenylsilyl), and a silyloxy group (the number of carbon atoms of the silyloxy group is preferably in a range of 3 to 40, more preferably in a range of 3 to 30, and particularly preferably in a range of 3 to 24, and examples thereof include trimethylsilyloxy and triphenylsilyloxy). These substituents may be substituted with any one or more substituents selected from the substituent group Z.

Further, in the present invention, when a plurality of substituents are present at one structural site, these substituents may be linked to each other and form a ring or may be condensed with some or entirety of the structural site and form an aromatic ring or an unsaturated hetero ring.

In the polyimide compound which can be used in the present invention, the ratios of the respective repeating units represented by Formulae (I), (II-a), (II-b), (III-a), and (III-b) are not particularly limited and appropriately adjusted in consideration of gas permeability and gas separation selectivity according to the purpose of gas separation (recovery rate, purity, or the like).

In the polyimide having a reactive group which can be used in the present invention, a ratio (E_{II}/E_{III}) of the total number (E_{II}) of moles of respective repeating units represented by Formulae (II-a) and (II-b) to the total number (E_{III}) of moles of respective repeating units represented by Formulae (III-a) and (III-b) is preferably in a range of 5/95 to 95/5, more preferably in a range of 10/90 to 80/20, and still more preferably in a range of 20/80 to 60/40.

The molecular weight of the polyimide having a reactive group which can be used in the present invention is preferably in a range of 10,000 to 1,000,000, more preferably in a range of 15,000 to 500,000, and still more preferably in a range of 20,000 to 200,000 as the weight-average molecular weight.

The molecular weight and the dispersity in the present specification are set to values measured using a gel permeation chromatography (GPC) method unless otherwise specified and the molecular weight is set to a weight-average molecular weight in terms of polystyrene. A gel including an aromatic compound as a repeating unit is preferable as a gel filled into a column used for the GPC method and a gel formed of a styrene-divinylbenzene copolymer is exemplified. It is preferable that two to six columns are connected to each other and used. Examples of a solvent to be used include an ether-based solvent such as tetrahydrofuran and an amide-based solvent such as N-methylpyrrolidinone. It is preferable that measurement is performed at a flow rate of the solvent of 0.1 mL/min to 2 mL/min and most preferable that the measurement is performed at a flow rate thereof of 0.5 mL/min to 1.5 mL/min. When the measurement is performed in the above-described range, a load is not applied to the apparatus and the measurement can be more efficiently performed. The measurement temperature is preferably in a range of 10° C. to 50° C. and most preferably in a range of 20° C. to 40° C. In addition, the column and the carrier to be used can be appropriately selected according to the physical properties of a polymer compound which is a target for measurement.

The polyimide having a reactive group which can be used in the present invention can be synthesized by performing condensation and polymerization of a specific bifunctional acid anhydride (tetracarboxylic dianhydride) and a specific diamine. As the method, a technique described in a general book (for example, “The Latest Polyimide Fundamentals and Applications˜” edited by Toshio Imai and Rikio Yokota, NTS Inc., pp. 3 to 49) can be appropriately selected.

Preferred specific examples of the polyimide having a reactive group which can be used in the present invention will be described below, but the present invention is not limited thereto. Further, “100,” “x,” and “y” in the following formulae indicate a copolymerization ratio (molar ratio). Examples of “x,” “y,” and the weight-average molecular weight are listed in the following Table 1. Moreover, in the polyimide compound which can be used in the present invention, it is preferable that y does not represent 0.

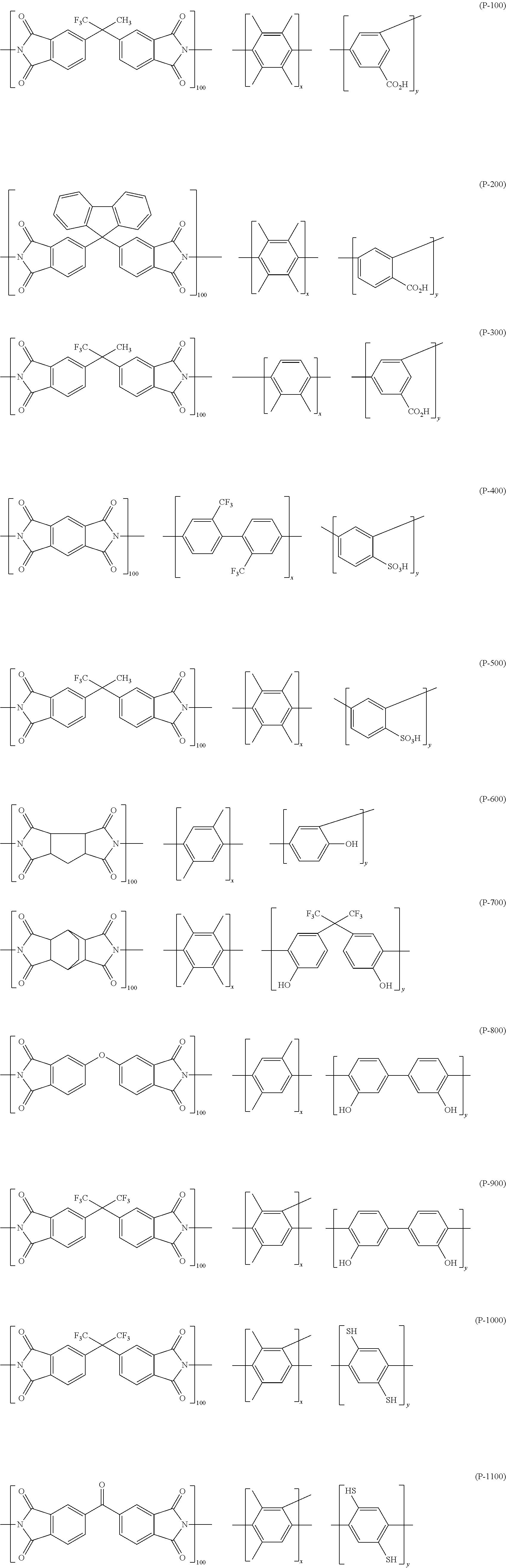

TABLE 1

| | |
|---|---|
| Copolymerization | |
| ratio | Weight-average |

| Polymer | x | y | molecular weight |
|---|---|---|---|
| P-100 | 30 | 70 | 132,000 |
| P-200 | 40 | 60 | 168,000 |
| P-300 | 60 | 40 | 165,000 |
| P-400 | 10 | 90 | 158,000 |
| P-500 | 20 | 80 | 128,000 |
| P-600 | 50 | 50 | 155,000 |
| P-700 | 70 | 30 | 112,500 |
| P-800 | 30 | 70 | 158,000 |
| P-900 | 20 | 80 | 128,000 |
| P-1000 | 60 | 40 | 150,000 |
| P-1100 | 40 | 60 | 117,000 |

Moreover, in the copolymerization ratio of the polyimide compound P-100 exemplified above, a polymer (P-101) in which x is set to 20 and y is set to 80 can be preferably used.

Further, in a case where the resin of the additional resin layer is polyimide, more specifically, MATRIMID 5218 that is put on the market under the trade mark of MATRIMID (registered trademark) registered by Huntsman Advanced Materials GmbH, and P84 and P84HT that are put on the market respectively under the trade names of P84 and P84HT registered by HP Polymers GmbH are preferable.

In addition, the resin of the additional resin layer other than polyimide can be selected from celluloses such as cellulose acetate, cellulose triacetate, cellulose acetate butyrate, cellulose propionate, ethyl cellulose, methyl cellulose, and nitrocellulose. As the celluloses which can be used for the additional resin layer, it is preferable that the degree of substitution of all acyl groups is in a range of 2.0 to 2.7. Cellulose acetate L-40 (degree of substitution of acyl groups: 2.5, manufactured by Daicel Corporation) which is commercially available as a product of cellulose acetate can be preferably used.

As other resins of the additional resin layer, polyethylene glycols such as a polymer obtained by polymerizing polyethylene glycol #200 diacrylate (manufactured by Shin-Nakamura Chemical Co., Ltd.); and a polymer described in JP2010-513021A can be selected.

Another additional resin layer may be interposed between the support and the separation layer containing a silsesquioxane compound. As another additional resin layer, a polyvinyl alcohol layer whose hydrophilicity and hydrophobicity are adjusted or the like may be exemplified.

(Characteristics)

It is preferable that the film thickness of the additional resin layer is as small as possible under the conditions of imparting high gas permeability while maintaining the mechanical strength and gas separation selectivity.

From the viewpoint of improving the gas permeability, it is preferable that the additional resin layer other than the separation layer containing a silsesquioxane compound is a thin layer. The thickness of the additional resin layer other than the separation layer containing a silsesquioxane compound is typically 10 μm or less, preferably 3 μm or less, more preferably 1 μm or less, still more preferably 0.3 μm or less, and particularly preferably 0.2 μm or less.

Further, the thickness of the additional resin layer other than the separation layer containing a silsesquioxane compound is typically 0.01 μm or greater, preferably 0.03 μm or greater from the practical viewpoint of ease of film formation, and more preferably 0.1 μm or greater.

<Protective Layer>

The gas separation membrane of the present invention includes a protective layer.

It is preferable that the protective layer is a layer provided separately from the separation layer.

The gas separation membrane may include a protective layer formed on the additional resin layer or the separation layer containing a silsesquioxane compound. It is preferable that the protective layer is a layer disposed on the separation layer containing a silsesquioxane compound. At the time of handling or use, unintended contact between the separation layer containing a silsesquioxane compound and another material can be prevented.

(Material)

The material of the protective layer is not particularly limited.

As the material used for the protective layer, those exemplified as the resin contained in the additional resin layer may be exemplified. Examples thereof include a silicone resin, polyimide, a cellulose resin, and polyethylene oxide.

Further, the protective layer may contain a filler. The filler used for the protective layer is not particularly limited. As the filler used for the protective layer, inorganic particles described in paragraphs <0020> to <0027> of JP2015-160201A can be preferably used, and the contents of this publication are incorporated herein by reference.

It is preferable that the protective layer in the gas separation membrane of the present invention contains a silicone resin. In this case, the content of the silicone resin in the protective layer is preferably 50% by mass or greater, more preferably 90% by mass or greater, and particularly preferably 99% by mass or greater. It is more preferable that the protective layer is formed of only a silicone resin.

As examples of the silicone resin used for the protective layer, it is preferable that the protective layer contains at least one selected from polydimethylsiloxane (hereinafter, also referred to as PDMS), polydiphenyl siloxane, polydi(trifluoropropyl)siloxane, polymethyl(3,3,3-trifluoropropyl)siloxane, and poly(1-trimethylsilyl-1-propyne) (hereinafter, also referred to as PTMSP), more preferable that the protective layer contains polydimethylsiloxane or poly(1-trimethylsilyl-1-propyne), and particularly preferable that the protective layer contains polydimethylsiloxane.

A commercially available material can be used as the silicone resin used for the protective layer. Examples thereof include UV9300 (polydimethylsiloxane (PDMS), manufactured by Momentive Performance Materials Inc.) and X-22-162C (manufactured by Shin-Etsu Chemical Co., Ltd.).

The silicone resin used for the protective layer can be prepared as a composition containing an organic solvent during formation of the protective layer, and it is preferable that the composition is a curable composition. The organic solvent which can be used for forming the protective layer containing a silicone resin is not particularly limited, and examples thereof include n-heptane.

Other examples of the silicone resin used for the protective layer include those having a D-body structure (also referred to as a D resin) represented by Formula D, a T-body structure (also referred to as a T resin) represented by Formula T, an M-body structure (also referred to as an M resin) represented by Formula M, and a Q-body structure (also referred to as a Q resin) represented by Formula Q at an optional copolymerization ratio.

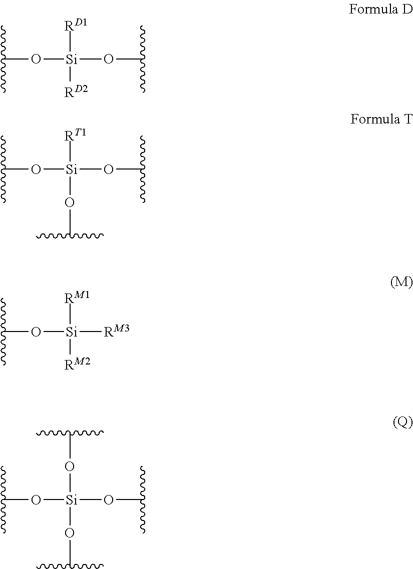

In Formulae T and D, R^{D1}, R^{D2}, and R^{T1} each independently represent a hydrogen atom or a substituent, preferably a methyl group, a substituted or unsubstituted phenyl group, or a substituted unsubstituted benzyl group, more preferably a methyl group or a substituted or unsubstituted phenyl group, and particularly preferably a methyl group or a phenyl group. Each wavy line portion represents a binding site with respect to another structure.

In Formulae M and Q, R^{M1}, R^{M2}, and R^{M3} each independently represent a hydrogen atom or a substituent, preferably an alkyl group, an aryl group, an allyl group, or a hydrogen atom, more preferably an alkyl group or an aryl group, more preferably an alkyl group having 1 to 4 carbon atoms, a phenyl group, or a naphthyl group, and particularly preferably a methyl group or a phenyl group. Each wavy line portion represents a binding site with respect to another structure.

A silicone resin can be produced according to a method of hydrolyzing a silane compound containing a hydrolyzable group to generate a silanol group, and heating the resultant for condensation.

Examples of the hydrolyzable group include an alkoxy group and a halogen atom. Among these, an alkoxy group having 1 to 4 carbon atoms or a chlorine atom is preferable.

In a case where the silicone resin has the structure represented by Formula T and the structure represented by Formula D, it is preferable that a silane compound containing three hydrolyzable groups capable of forming the structure represented by Formula T after condensation and a silane compound containing two hydrolyzable groups capable of forming the structure represented by Formula D are condensed. Further, in a case where the silicone resin has the structure represented by Formula M and the structure represented by Formula Q, it is preferable that a silane compound containing one hydrolyzable group and a silane compound containing four hydrolyzable groups are condensed.

It is more preferable that the silicone resin used for the protective layer contains a Si⁴⁺ component from the viewpoint of improving initial gas separation performance and gas permeability after a rub resistance test and particularly preferable that the silicone resin contains a Q resin.

It is particularly preferable that the silicone resin used for the protective layer in this case is at least one selected from Q resin-containing polydimethylsiloxane (PDMS), polydimethylsiloxane, poly(1-trimethylsilyl-1-propyne) and more particularly preferable that the silicone resin is Q resin-containing PDMS.

The O/Si ratio which is the ratio of the number of oxygen atoms to the number of silicon atoms inside the protective layer is preferably less than 1.65 from the viewpoint of improving initial gas separation performance and gas permeability after a rub resistance test, more preferably in a range of 1.00 to 1.60, and particularly preferably in a range of 1.00 to 1.40. The term “inside” the protective layer indicates a portion on a side of a surface of the resin layer, which contains a compound having a siloxane bond, opposite to the support. It is preferable that the “inside” the protective layer includes a portion having an O/Si ratio of less than 1.7.

It is preferable that the protective layer in the gas separation membrane contains polyimide.

Examples of the polyimide used for the protective layer include those described as examples of the polyimide used for the additional resin layer.

The protective layer of the gas separation membrane may contain a cellulose resin.

As the celluloses resin used for the protective layer, those described in paragraphs <0038> and <0039> of WO2013/046975A can be exemplified, and the contents of these publications are incorporated herein by reference.

(Characteristics)

From the viewpoint of increasing the hydrophobicity of the protective layer so that the moisture is not allowed to permeate into the separation layer, the pure water contact angle in a case where pure water at 25° C. is dropped on the surface of the protective layer in the gas separation membrane of the present invention is preferably 30° or greater, more preferably 50° or greater, and particularly preferably 90°. The gas permeability of the separation layer containing a silsesquioxane compound is deteriorated over time because of the influence of the separation layer assumed to absorb water. On the contrary, it is preferable that a hydrophobic protective layer is provided for the separation layer containing a silsesquioxane compound in order to suppress deterioration of the gas permeability over time. The upper limit of the pure water contact angle in a case where pure water at 25° C. is dropped on a surface of the protective layer is not particularly limited, and it is preferable that the pure water contact angle is set to 120° or less from the viewpoint of preventing a significant reduction in affinity for carbon dioxide.

In a case where the gas separation membrane includes two or more protective layers, it is preferable that the pure water contact angle in a case where pure water at 25° C. is dropped on a surface of the protective layer on a side close to the separation layer containing a silsesquioxane compound is in the above-described range. It is more preferable that the pure water contact angle in a case where pure water at 25° C. is dropped on a surface of the protective layer in direct contact with the separation layer containing a silsesquioxane compound is in the above-described range. In this case, the protective layer on a side far from the separation layer containing a silsesquioxane compound may be hydrophilic or hydrophobic.

The thickness of the protective layer can be set to be in a range of 50 to 4000 nm. In the gas separation membrane of the present invention, the thickness of the protective layer is in a range of 100 to 3500 nm from the viewpoint of achieving both of scratch resistance and gas permeability, more preferably in a range of 100 to 1000 nm, and particularly preferably in a range of 100 to 500 nm.

In the field of water separation for which durability is further required than the field of the gas separation membrane, since the thickness of the separation layer is basically in a range of 2 to 3 μm or greater, which is thick, a protective layer is not necessary. On the contrary, in the field of the gas separation membrane including the present invention in which the thickness of the separation layer is basically 500 nm or less and which is easily affected by damage, it is preferable to make the membrane thin to the extent that the gas permeability can be increased as much as possible while the scratch resistance is held.

The protective layer may be adjacent to the following porous layer.

It is preferable that the protective layer includes a region PLi present in the porous layer and a region PLe present on the porous layer and the permeation rate of the protective layer into the porous layer which is represented by the following formula is controlled.

Permeation rate of protective layer into porous layer=100%×(thickness of PLi)/(thickness of PLi+thickness of PLe)

From the viewpoint of improving the rub resistance and bending resistance, the permeation rate of the protective layer into the porous layer is preferably 95% or less.

From the viewpoint of improving the rub resistance using an anchoring action of the protective layer to the porous layer, it is preferable that the protective layer includes the region PLi present in the porous layer and the region PLe present on the porous layer and the permeation rate of the protective layer into the porous layer which is represented by the above-described formula is in a range of 10% to 90%. Specifically, the permeation rate of the protective layer into the porous layer is preferably 10% or greater from the viewpoint of improving the rub resistance, more preferably 12% or greater, and particularly preferably 15% or greater. The permeation rate of the protective layer into the porous layer is more preferably 90% or less from the viewpoint of improving the rub resistance and particularly preferably 85% or less.

<Porous Layer>

The gas separation membrane of the present invention may include a porous layer (porous layer on the protective layer side).

The porous layer indicates a layer in which a permeability coefficient (PCO₂) of carbon dioxide, in a case where a membrane having a thickness of 0.1 to 30 μm is formed and pure gas of carbon dioxide (CO₂) is supplied to the obtained membrane at a temperature of 40° C. by setting the total pressure of the gas supply side to 0.5 MPa, is 2000 barrer or greater.

The material of the porous layer (porous layer on the protective layer side) is not particularly limited, and the same material as the material forming the porous layer used for the support may be used.

<Characteristics and Applications>

The separation membrane of the present invention can be suitably used according to a gas separation recovery method and a gas separation purification method. For example, a gas separation membrane which is capable of efficiently separating specific gas from a gas mixture containing gas, for example, hydrogen, helium, carbon monoxide, carbon dioxide, hydrogen sulfide, oxygen, nitrogen, ammonia, a sulfur oxide, or a nitrogen oxide; hydrocarbon such as methane, or ethane; unsaturated hydrocarbon such as propylene; or a perfluoro compound such as tetrafluoroethane can be obtained.

It is preferable that the gas separation membrane of the present invention is used to separate at least one kind of acidic gas from a gas mixture of acidic gas and non-acidic gas. Examples of the acidic gas include carbon dioxide, hydrogen sulfide, carbonyl sulfide, a sulfur oxide (SOx), and a nitrogen oxide (NOx). Among these, at least one selected from carbon dioxide, hydrogen sulfide, carbonyl sulfide, a sulfur oxide (SOx), and a nitrogen oxide (NOx) is preferable; carbon dioxide, hydrogen sulfide, or a sulfur oxide (SOx) is more preferable; and carbon dioxide is particularly preferable.

As the non-acidic gas, at least one selected from hydrogen, methane, nitrogen, and carbon monoxide is preferable; methane or hydrogen is more preferable, and methane is particularly preferable.

It is preferable that the gas separation membrane of the present invention selectively separates carbon dioxide from the gas mixture including particularly carbon dioxide and hydrocarbon (methane).

In addition, in a case where gas subjected to a separation treatment is mixed gas of carbon dioxide and methane, the permeation rate of the carbon dioxide at 30° C. and 5 MPa is preferably 10 GPU or greater, more preferably in a range of 10 to 300 GPU, and particularly preferably in a range of 15 to 300 GPU.

Further, 1 GPU is 1×10⁻⁶ cm³(STP)/cm²·sec·cmHg.

In the case where the gas separation membrane of the present invention is a membrane in which the gas subjected to a separation treatment is mixed gas of carbon dioxide and methane, a gas separation selectivity a which is a ratio of the permeation flux of carbon dioxide at 30° C. and 5 MPa to the permeation flux of methane is preferably 30 or greater, more preferably 35 or greater, particularly preferably 40 or greater, and more particularly preferably greater than 50.

It is considered that a mechanism of dissolution and diffusion in a membrane is involved in the selective gas permeation. From this viewpoint, a separation membrane including a polyethyleneoxy composition is examined (see Journal of Membrane Science, 160 (1999), pp. 87 to 99). This is because interaction between carbon dioxide and the polyethyleneoxy composition is strong. Since this polyethyleneoxy film is a flexible rubber-like polymer film having a low glass transition temperature, a difference in the diffusion coefficient resulting from the kind of gas is small and the gas separation selectivity is mainly due to the effect of a difference in solubility. Meanwhile, the preferred embodiments of the present invention can be significantly improved from the viewpoints of the high glass transition temperature of the silsesquioxane compound contained in the separation layer that contains a silsesquioxane compound and the thermal durability of the membrane while the above-described action of dissolution and diffusion is exhibited.

[Method of Producing Gas Separation Membrane]

A method of producing a gas separation membrane of the present invention is not particularly limited.

It is preferable that the method of producing a gas separation membrane of the present invention is a method of producing the gas separation membrane of the present invention described below.

The method of producing a gas separation membrane of the present invention is a method of producing the gas separation membrane of the present invention and includes a step of forming a film by reacting the separation layer using a sol-gel method to synthesize the silsesquioxane compound.

According to the method of producing the gas separation membrane of the present invention, it is preferable that the reaction carried out using the sol-gel method is initiated or promoted by photo-excitation.

Hereinafter, preferred aspects of the method of producing the gas separation membrane of the present invention will be described.

<Formation of Separation Layer Containing Silsesquioxane Compound>

It is preferable that the method of producing the gas separation membrane of the present invention includes a step of forming a separation layer precursor that contains a silsesquioxane compound on the support.

A method of forming the separation layer precursor that contains a silsesquioxane compound on the support is not particularly limited, and it is preferable that the support is coated with the composition containing a solvent and the material of the separation layer that contains a silsesquioxane compound. The coating method is not particularly limited and a known method can be used. As the known method, a spin coating method, a dip coating method, or a bar coating method can be used as appropriate. At this time, the organic solvent may be evaporated by drying the composition in a temperature range of 25° C. to 60° C. In addition, a required thickness can be obtained by repeatedly performing the coating a plurality of times.

It is preferable that the composition containing a solvent and the material of the separation layer that contains a silsesquioxane compound is a curable composition and more preferable that the composition is a curable composition which can react according to a sol-gel method that is initiated or promoted by photo-excitation.

According to an example of curing procedures, first, alkoxysilane is heated at 50° C. for 1 hour under acidic conditions containing an acid such as acetic acid to obtain a sol. Before or after this process, a photopolymerization initiator (preferably, a photoinduced radical polymerization initiator or a cationic polymerization initiator) is added. Next, the support is coated with this sol composition and irradiated with light to further promote the sol-gel reaction. Further, in a case where a polymerizable functional group is present, polymerization of this functional group is performed.

The hydrolysis and polycondensation of the material forming the separation layer that container a silsesquioxane compound may be initiated before or after irradiation with radiation.

It is preferable that a radical polymerization initiator and a cationic polymerization initiator is added before the composition containing a solvent and the material of the separation layer that contains a silsesquioxane compound is irradiated with radiation. As the timing of adding the radical polymerization initiator and a cationic polymerization initiator, it is preferable that the initiators are added in a sol state in which the hydrolysis and polycondensation of alkoxysilane are promoted to some extent.

It is preferable that the separation layer containing a silsesquioxane compound is formed by initiating or promoting radical polymerization by irradiation with radiation. A method of irradiating a curable composition with radiation during formation of the separation layer containing a silsesquioxane compound is not particularly limited, and electron beams, ultraviolet (UV) rays, visible light, or infrared rays can be used for irradiation, the method can be appropriately selected according to the material to be used. As the radiation applied to the curable composition during formation of the separation layer containing a silsesquioxane compound, it is preferable to use ultraviolet rays.

The time for irradiation with radiation is preferably in a range of 1 to 60 minutes and more preferably in a range of 2 to 30 minutes.

The temperature of the curable composition at the time of irradiation with radiation is preferably 100° C. or lower and more preferably 80° C. or lower.

Further, according to another preferred aspect of the reaction carried out according to a sol-gel method, initiated or promoted by photo-excitation which can be used in the present invention, the time for curing carried out through a photopolymerization reaction after coating is shortened by promoting the solation reaction until an appropriate reaction rate is obtained before the coating.

<Method of Preparing Additional Resin Layer>

A method of preparing the additional resin layer other than the separation layer containing a silsesquioxane compound is not particularly limited, and the additional resin layer may be formed by obtaining a commercially available product of a known material, may be formed according to a known method, or may be formed according to a method described below using a specific resin.

The method of forming the additional resin layer other than the separation layer containing a silsesquioxane compound is not particularly limited, but it is preferable that an underlayer (for example, a separation layer containing a silsesquioxane compound) is coated with the composition containing an organic solvent and the material of the additional resin layer other than the separation layer containing a silsesquioxane compound. The coating method is not particularly limited and the coating can be performed according to a known method, for example, a spin coating method.

The conditions for forming the additional resin layer other than the separation layer containing a silsesquioxane compound of the gas separation membrane of the present invention are not particularly limited, but the temperature thereof is preferably in a range of −30° C. to 100° C., more preferably in a range of −10° C. to 80° C., and particularly preferably in a range of 5° C. to 50° C.

In the present invention, the air and a gas such as oxygen may coexist at the time of forming the additional resin layer other than the separation layer containing a silsesquioxane compound, but it is desired that the additional resin layer is formed in an inert gas atmosphere.

<Formation of Protective Layer>

It is preferable that the method of producing the gas separation membrane includes a step of forming a protective layer.

The method of forming a protective layer on the surface of the separation layer containing a silsesquioxane compound is not particularly limited, but it is preferable to coat the surface with the composition containing an organic solvent and the material of the protective layer. Examples of the organic solvent include organic solvents used to form the separation layer containing a silsesquioxane compound. The coating method is not particularly limited and a known method can be used. For example, the coating can be performed according to a spin coating method.

The method of irradiating a curable composition with radiation when the protective layer is formed is not particularly limited. Since electron beams, ultraviolet (UV) rays, visible light, or infrared rays can be used for irradiation, the method can be appropriately selected according to the material to be used.

The time for irradiation with radiation is preferably in a range of 1 to 30 seconds.

The radiant energy is preferably 10 to 2,000 mW/cm².

The method of producing the gas separation membrane may include a step of further providing a porous layer for the protective layer.

The method of producing a porous layer for the protective layer is not particularly limited.

The gas separation membrane may be produced by bonding the laminate of the porous layer and the protective layer to the separation layer containing a silsesquioxane compound in the gas separation membrane or produced by sequentially laminating the protective layer and the porous layer. From the viewpoint of easily controlling the permeation rate of the protective layer into the porous layer, it is preferable that the gas separation membrane the gas separation membrane is produced by bonding the laminate of the porous layer and the protective layer to the separation layer containing a silsesquioxane compound in the gas separation membrane.

It is preferable that the method of producing the gas separation membrane includes a step of bonding the laminate of the porous layer and the protective layer to the separation layer containing a silsesquioxane compound in the gas separation membrane. Specifically, it is preferable that the gas separation membrane is produced by bringing the surface, on the protective layer side between the porous layer and the protective layer in the laminate, into contact with the surface of the separation layer containing a silsesquioxane compound in the gas separation membrane. By bringing the surface, on the protective layer side between the porous layer and the protective layer in the laminate, into contact with the surface of the separation layer containing a silsesquioxane compound in the gas separation membrane, the separation layer containing a silsesquioxane compound and the protective layer in the gas separation membrane can be allowed to be adjacent to each other and bonded to each other, which is more preferable from the viewpoint of improving the initial gas separation performance and rub resistance. It is preferable that the surface of the separation layer containing a silsesquioxane compound in the gas separation membrane has tackiness. Further, the laminate of the porous layer and protective layer may be bonded to the separation layer containing a silsesquioxane compound in the gas separation membrane through an adhesive or a pressure sensitive adhesive.

<Method of Separating Gas Mixture>

Using the gas separation membrane of the present invention, it is possible to perform separation of a gas mixture.

In the method of separating a gas mixture used for the gas separation membrane of the present invention, the components of the gas mixture of raw materials are affected by the production area of the raw materials, the applications, or the use environment and are not particularly defined, but it is preferable that the main components of the gas mixture are carbon dioxide and methane, carbon dioxide and nitrogen, or carbon dioxide and hydrogen. That is, the proportion of carbon dioxide and methane or carbon dioxide and hydrogen in the gas mixture is preferably in a range of 5% to 50% and more preferably in a range of 10% to 40% in terms of the proportion of carbon dioxide. In a case where the gas mixture is present in the coexistence of an acidic gas such as carbon dioxide or hydrogen sulfide, the method of separating the gas mixture using the gas separation membrane of the present invention exhibits particularly excellent performance. Preferably, the method thereof exhibits excellent performance at the time of separating carbon dioxide and hydrocarbon such as methane, carbon dioxide and nitrogen, or carbon dioxide and hydrogen.

It is preferable that the gas separation membrane of the present invention allows carbon dioxide to selectively permeate from mixed gas including carbon dioxide gas other than carbon dioxide. It is preferable that the method of separating a gas mixture includes a process of allowing carbon dioxide to selectively permeate from mixed gas including carbon dioxide and methane. The pressure during gas separation is preferably in a range of 3 MPa to 10 MPa, more preferably in a range of 4 MPa to 7 MPa, and particularly preferably in a range of 5 MPa to 7 MPa. Further, the temperature during gas separation is preferably in a range of −30° C. to 90° C. and more preferably in a range of 15° C. to 70° C.

[Gas Separation Membrane Module and Gas Separator]

A gas separation membrane module of the present invention includes the gas separation membrane of the present invention. The gas separation membrane module may be produced by being cut out from the gas separation membrane in a roll shape and performing processing.

It is preferable that the gas separation membrane of the present invention is used for a thin layer composite membrane obtained by combining with a porous support and also preferable that the gas separation membrane is used for a gas separation membrane module using this thin layer composite membrane. Further, using the gas separation membrane, the thin layer composite membrane, or the gas separation membrane module of the present invention, a gas separator having means for performing separation and recovery of gas or performing separation and purification of gas can be obtained. The gas separation membrane of the present invention can be made into a module and suitably used. Examples of the module include a spiral type module, a hollow fiber type module, a pleated module, a tubular module, and a plate & frame type module. The gas separation membrane of the present invention may be applied to a gas separation and recovery apparatus which is used together with an absorption liquid described in JP2007-297605A according to a membrane/absorption hybrid method.

### EXAMPLES

The characteristics of the present invention will be described in detail with reference to examples and comparative examples (the comparative examples do not correspond to known techniques) described below. The materials, the amounts to be used, the ratios, the treatment contents, and the treatment procedures shown in the examples described below can be appropriately changed as long as it is within the gist of the present invention. Accordingly, the scope of the present invention should not be limitatively interpreted by the specific examples described below.

Moreover, “part” and “%” in the sentences are on a mass basis unless otherwise noted.

### Example 1

<Forming Separation Layer Containing Silsesquioxane Compound>

A separation layer containing a silsesquioxane compound was formed on the support according to the method described in Chem. Commun., 2015, 51, p. 9932 to 9935.

Specifically, 3-methacryloxypropyltrimethoxysilane (MAPTMS, manufactured by Shin-Nakamura Chemical Co., Ltd.) was used as a material monomer which was able to react according to a sol-gel method, initiated or promoted by photo-excitation. A sol derived from MAPTMS was prepared by mixing MAPTMS, H₂O, and AcOH at a molar ratio of 1:6:0.03, hydrolyzing the mixture at 50° C. for 1 hour, and causing a polymerization reaction. AcOH is an abbreviation standing for acetic acid.

Thereafter, Darocure 1173 and Irgacure 250 (both manufactured by BASF Corporation) were added thereto as a radical photopolymerization initiator and a cationic photopolymerization initiator. The mass ratios of Darocure 1173 and Irgacure 250 to be added were respectively 0.03 parts by mass and 0.02 parts by mass with respect to 1 part by mass of MAPTMS.

A polyacrylonitrile (PAN) porous membrane (a polyacrylonitrile porous membrane is present on non-woven fabric, the film thickness of the membrane including the non-woven fabric is approximately 180 μm) used as a porous support was spin-coated with the separation layer containing a silsesquioxane compound derived from MAPTMS, the resulting membrane was dried at room temperature for 30 minutes, and irradiated with ultraviolet rays at a temperature of lower than 80° C. for 20 minutes using a metal halide lamp (250 W, 250 to 450 nm), thereby forming the separation layer. The separation layer containing a silsesquioxane compound derived from MAPTMS was irradiated with ultraviolet rays in a quartz cell in a N₂ flow for the purpose of avoiding deactivation of radicals used for photoradical polymerization.

(O/Si Ratio of Separation Layer and Composition of Separation Layer in Thickness Direction)

The center of the porous support on which the separation layer containing a silsesquioxane compound was formed was sampled. Further, the O/Si ratio (surface) which is the ratio of the number of oxygen atoms to the number of silicon atoms in the surface of the separation layer containing a silsesquioxane compound was calculated using electron spectroscopy for chemical analysis (ESCA). Similarly, the O/Si ratio (45 nm) which is the ratio of the number of oxygen atoms to the number of silicon atoms contained in the separation layer containing a silsesquioxane compound at a depth of 45 nm from the surface of the separation layer containing a silsesquioxane compound was calculated using ESCA.

The porous support on which the separation layer containing a silsesquioxane compound was formed was put into Quantera SXM (manufactured by Physical Electronics, Inc.). The O/Si ratio (surface) which is a ratio of the number of oxygen atoms to the number of silicon atoms in the surface of the separation layer containing a silsesquioxane compound was calculated under conditions of using Al-Kα rays (1,490 eV, 25 W, diameter of 100 μm) as an X-ray source with Pass Energy of 55 eV and Step of 0.05 eV in a measuring region having a size of 300 μm×300 μm. Further, the surface of the separation layer on which measurement of O/Si ratio (surface) was performed is the surface of the separation layer on the opposite side of the porous support, in other words, the surface of the separation layer on the protective layer side.

Next, in order to acquire the O/Si ratio (45 nm) which is a ratio of the number of oxygen atoms to the number of silicon atoms contained in the separation layer containing a silsesquioxane compound at a depth of 45 nm from the surface of the separation layer containing a silsesquioxane compound, etching was performed using C₆₀ ions. In other words, the ion beam intensity was set to C₆₀⁺ of 10 keV and 10 nA and a region having a size of 2 mm×2 mm was etched by 45 nm using a C₆₀ ion gun belonging to Quantera SXM (manufactured by Physical Electronics, Inc.). With this membrane, the O/Si ratio (45 nm) which is a ratio of the number of oxygen atoms to the number of silicon atoms in the surface of the separation layer containing a silsesquioxane compound was calculated using an ESCA device. The depth of the separation layer containing a silsesquioxane compound from the surface of the separation layer containing a silsesquioxane compound was calculated at an etching rate of 10 nm/min of the material of the separation layer containing a silsesquioxane compound. This value was able to be acquired whenever the material was changed and an optimum numerical value was appropriately used for the material.

The obtained O/Si ratio (45 nm) which is the ratio of the number of oxygen atoms to the number of silicon atoms contained in the separation layer containing a silsesquioxane compound at a depth of 45 nm from the surface of the separation layer containing a silsesquioxane compound and the obtained O/Si ratio (surface) which is a ratio of the number of oxygen atoms to the number of silicon atoms in the surface of the separation layer containing a silsesquioxane compound are listed in Table 2.

The O/Si ratio (90 nm) which is the ratio of the number of oxygen atoms to the number of silicon atoms of the separation layer containing a silsesquioxane compound at a depth of 90 nm from the surface of the separation layer containing a silsesquioxane compound was acquired according to the same method as that for acquiring the O/Si ratio (45 nm) which is the ratio of the number of oxygen atoms to the number of silicon atoms contained in the separation layer containing a silsesquioxane compound at a depth of 45 nm from the surface of the separation layer containing a silsesquioxane compound. The O/Si ratio (90 nm) is listed in Table 2.

The surface of the separation layer containing a silsesquioxane compound is a surface which has a maximum 0/Si ratio in a case where the O/Si ratio is measured from the surface of the gas separation membrane and contains 3% (atomic %) or greater of silicon atoms. The surface in which the O/Si ratio was the maximum, in a case where the O/Si ratio was measured from the surface of the gas separation membrane using the same method as the method of acquiring the O/Si ratio (45 nm) which is a ratio of the number of oxygen atoms to the number of silicon atoms of the separation layer containing a silsesquioxane compound at a depth of 45 nm from the surface of the separation layer containing a silsesquioxane compound, and the number of silicon atoms was 3% (atomic %) or greater was specified.

(Composition of Separation Layer in Thickness Direction)

The variation in composition of the separation layer in the thickness direction was acquired as a percentage by dividing a difference between the maximum value and the minimum value among the O/Si ratio (surface), the O/Si ratio (45 nm), and the O/Si ratio (90 nm) by the average value of the O/Si ratio (surface), the O/Si ratio (45 nm), and the O/Si ratio (90 nm). In Example 1, the variation in composition of the separation layer in the thickness direction was 2.7%.

The results obtained by evaluating the composition of the separation layer in the thickness direction based on the following standards are listed in Table 2.

Uniform: The variation in composition of the separation layer in the thickness direction was 10% or less.

Ununiform: The variation in composition of the separation layer in the thickness direction was greater than 10%.

It was confirmed that the silsesquioxane compound was contained in the surface of the separation layer containing a silsesquioxane compound according to the following method.

The Si 2p spectrum was measured using ESCA and the valence of Si (Si²⁺, Si³⁺, and Si⁴⁺) was separated and quantified from the curve fitting of obtained peaks.

It was confirmed that the silsesquioxane compound was contained in the separation layer containing a silsesquioxane compound at a depth of 45 nm and a depth of 90 nm from the surface of the separation layer containing a silsesquioxane compound according to the following method.

The Si 2p spectrum was measured using ESCA by performing an etching treatment in the same manner as in the examples and the valence of Si (Si²⁺, Si³⁺, and Si⁴⁺) was separated and quantified from the curve fitting of obtained peaks.

<Formation of Protective Layer>

A protective layer containing a PDMS-based silicone resin was formed on the obtained separation layer containing a silsesquioxane compound according to the following method.

39 g of UV9300 (manufactured by Momentive Performance Materials Inc.), 10 g of X-22-162C (manufactured by Shin-Etsu Chemical Co., Ltd.), and 0.007 g of DBU (1,8-diazabicyclo[5.4.0]undec-7-ene) were added to a 150 ml three-neck flask and then dissolved in 50 g of n-heptane. The solution was maintained at 95° C. for 168 hours, thereby obtaining a radiation-curable polymer solution (viscosity of 22.8 mPa·s at 25° C.) having a poly(siloxane) group.

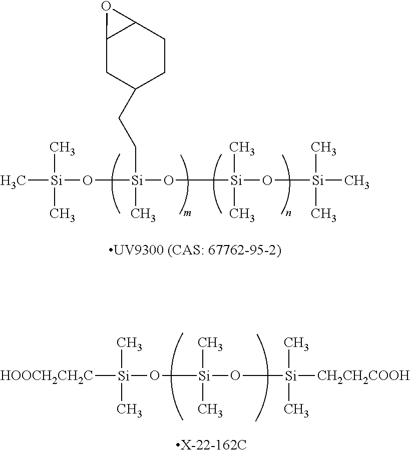

5 g of the radiation-curable polymer solution cooled to 20° C. was diluted with 95 g of n-heptane. 0.5 g of UV9380C (manufactured by Momentive Performance Materials Inc.) as a photopolymerization initiator and 0.1 g of ORGATICS TA-10 (manufactured by Matsumoto Fine Chemical Co., Ltd.) were added to the obtained solution, thereby preparing a polymerizable radiation-curable composition. The obtained polymerizable radiation curable composition was formed into a protective layer coating solution.

The separation layer containing a silsesquioxane compound was spin-coated with the protective layer coating solution, subjected to a UV treatment (Light Hammer 10, D-VALVE, manufactured by Fusion UV System Corporation) under conditions of a UV intensity of 24 kW/m for a treatment time of 10 seconds, and then dried. In this manner, a protective layer having a thickness of 80 nm was formed.

The composite membrane including the obtained separation layer containing a silsesquioxane compound and a protective layer provided separately from the separation layer was formed into a gas separation membrane in Example 1.

### Examples 2 to 5

Gas separation membranes of Examples 2 to 5 were produced in the same manner as in Example 1 except that the thickness of the protective layer was changed to the thickness listed in Table 2 by changing the thickness of the membrane coated with the protective layer coating solution.

### Example 6

<Protective Layer Coating Solution>

962 g of VQM-146 (trade name, manufactured by Gelest, Inc., the following structure) and an extremely small amount of 38 g of HMS-301 (trade name, manufactured by Gelest, Inc., the following structure) were dissolved in 9000 g of heptane. Next, 1.2 g of SIP6832.2 (trade name, manufactured by Gelest, Inc., the following structure) was added thereto to cause a reaction at 80° C. for 10 hours. Further, 0.4 g of 2-methyl-3-butyl-2-ol (manufactured by Sigma-Aldrich Co. LLC.) was added thereto, thereby obtaining a vinyl pre-crosslinking solution (a solution of a crosslinkable polysiloxane compound (a)) having the following structure.

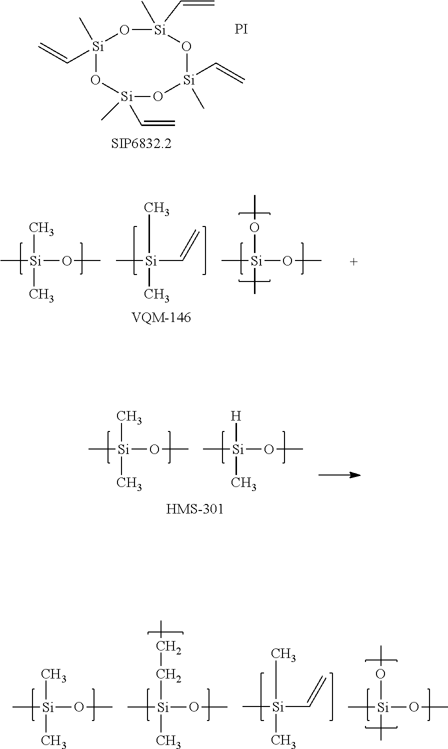

An excess amount of 150 g of HMS-301 (trade name, manufactured by Gelest, Inc.) and 850 g of VQM-146 (trade name, manufactured by Gelest, Inc.) were dissolved in 9000 g of heptane. Next, 1.2 g of SIP6832.2 (trade name, manufactured by Gelest, Inc.) was added thereto to cause a reaction at 80° C. for 10 hours. Further, 0.4 g of 2-methyl-3-butyl-2-ol (manufactured by Sigma-Aldrich Co. LLC.) was added thereto, thereby obtaining a hydro pre-crosslinking solution (a solution of a crosslinkable polysiloxane compound (b)) having the following structure.

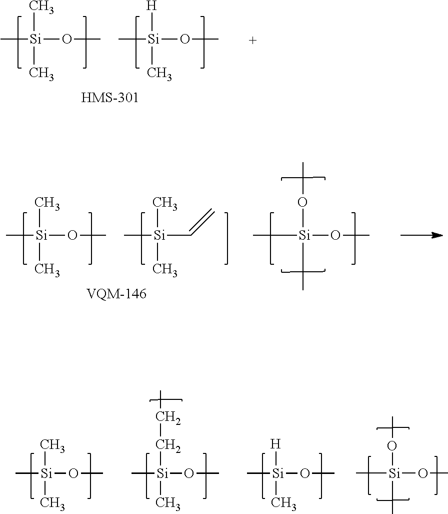

The obtained vinyl pre-crosslinking solution and the hydro pre-crosslinking solution were mixed at a ratio of 10:1 to obtain a protective layer coating solution.

In a case where film formation is made using this protective layer coating solution, a protective layer containing Q resin-containing PDMS can be formed according to a reaction scheme for forming a protective layer shown below. Further, in the reaction scheme for forming a protective layer shown below, the right side schematically shows the structural unit after a crosslinking reaction of the vinyl pre-crosslinking solution and the hydro pre-crosslinking solution. In other words, among structural units after the curing reaction according to the reaction scheme for forming a protective layer, the structural unit containing an ethylene group includes a structural unit newly formed by reacting the structural unit containing a vinyl group and the structural unit containing a hydrosilyl group which are contained in the vinyl pre-crosslinking solution and the hydro pre-crosslinking solution before the curing reaction in addition to the structural unit containing an ethylene group which is contained in the vinyl pre-crosslinking solution and the hydro pre-crosslinking solution before the curing reaction.

Reaction Scheme for Forming Protective Layer

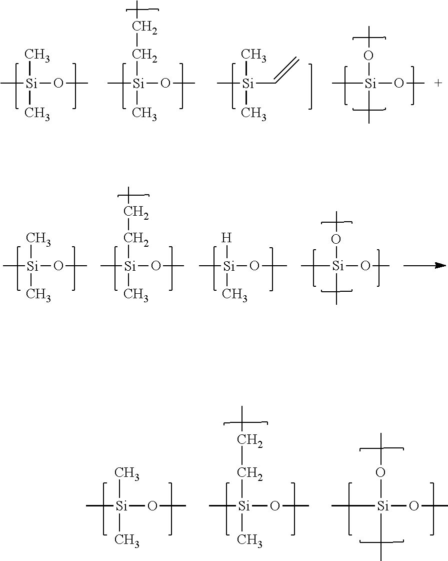

<Surface Oxidation Treatment of Composite and Provision of Protective Layer>

The surface of the separation layer containing a silsesquioxane compound produced in the process of producing the gas separation membrane of Example 1 was coated with the protective layer coating solution prepared in the above-described manner, and the protective layer coating solution was dried (90° C.) using a drying device. The gas separation membrane having a thickness of 1000 nm obtained in this manner was formed into a gas separation membrane of Example 6.

(O/Si Ratio of Protective Layer)

The number of silicon atoms and the number of oxygen atoms in the protective layer were calculated according to the same method as that for calculating the number of silicon atoms and the number of oxygen atoms in the separation layer containing a silsesquioxane compound.

The O/Si ratio of the number of oxygen atoms to the number of silicon atoms inside the protective layer was calculated, and the value was 1.05.

(Confirmation of Si4+ of Protective Layer)

It was confirmed that the Si⁴⁺ component was contained in the protective layers formed in Examples 6 and 7 by measuring the Si 2p spectra of the protective layers formed in Examples 6 and 7 using ESCA in the same manner as that for the separation layer containing a silsesquioxane compound and separating and quantifying the valence of Si (Si²⁺, Si³⁺, and Si⁴⁺) from the curve fitting of obtained peaks.

In other words, it was confirmed that the compositions of the protective layers formed in Examples 6 and 7 were respectively Q resin-containing PDMS.

### Example 7

<Formation of Protective Layer and Porous Layer>

A polyacrylonitrile (PAN) porous membrane (the polyacrylonitrile porous membrane was present on non-woven fabric, the thickness of the membrane including the non-woven fabric was approximately 200 μm) was spin-coated with the protective layer coating solution prepared in Example 6 under conditions of a rotation speed of 3000 rpm and a dropwise addition amount of 0.025 ml/cm² and then stored at room temperature for 1 minute. Thereafter, the protective layer coating solution was subjected to a UV treatment (Light Hammer 10, D-VALVE, manufactured by Fusion UV System Corporation) under conditions of a UV intensity of 24 kW/m² for a UV irradiation time of 10 seconds, and then the protective layer coating solution was cured. In the PAN porous membrane, a region which was not nearly filled with the compound having a siloxane bond was formed into a porous layer and the remaining region was formed into a region PLi present in the porous layer of the protective layer.

In this manner, a laminate of a protective layer and a porous layer was formed. The protective layer includes a region PLi (thickness of 800 nm) present in the porous layer of the protective layer and a region PLe (thickness of 200 nm) present on the porous layer of the protective layer, and the total thickness thereof was 1000 nm.

(Calculation of PLe and PLi)

The thickness of the protective layer was measured as follows.

The measurement was performed using time-of-flight secondary ion mass Spectrometry (TOF-SIMS, TRIFT V nano TOF) provided with an Ar-GCIB gun (manufactured by ULVAC-PHI, Inc.). Bi3++ (30 kV) was used as a primary ion source. A 20 eV electron gun was used together to neutralize the charge. Ar-GCIB (Ar2500+, 15 kV) was used for analyzing the depth direction. The thicknesses of PLe and PLi were measured by acquiring the maximum intensity of the peak intensity derived from silicone.

Permeation rate of protective layer into porous layer=100%×(thickness of PLi)/(thickness of PLi+thickness of PLe)

The surface (interface between the separation layer and the protective layer) of the separation layer containing a silsesquioxane compound can be analyzed using a cross section SEM image.

<Adhesion of Protective Layer>

The laminate of the protective layer and the porous layer was allowed to adhere to the surface of the separation layer containing a silsesquioxane compound produced in the process of producing the gas separation membrane of Example 1. Specifically, the separation layer containing a silsesquioxane compound was brought into contact with the protective layer in the laminate such that the separation layer and the protective layer were adjacent to each other, and bonded to the protective layer using a rubber roller. The obtained gas separation membrane was formed into a gas separation membrane of Example 7.

### Example 8

A gas separation membrane of Example 8 was prepared in the same manner as in Example 1 except that a cellulose-based protective layer having a thickness of 100 nm was formed using the following cellulose-based protective layer coating solution as the protective layer coating solution.

The cellulose-based protective layer coating solution was prepared according to the following method.

HEC Daicel (hydroxyethyl cellulose) SP200 (manufactured by Daicel Corporation) was dissolved in butanol to adjust a 1 mass % solution, thereby obtaining a protective layer coating solution. The separation layer containing a silsesquioxane compound was spin-coated with the protective layer coating solution under conditions of a rotation speed of 1000 rounds per minute (rpm) and a dropwise addition amount of 0.025 ml/cm², and the protective layer coating solution was dried (90° C.) using a drying device, thereby obtaining a gas separation membrane of Example 8.

### Example 9

A gas separation membrane of Example 9 was prepared in the same manner as in Example 1 except that a protective layer containing a polyimide-based polymer (P-101) and having a thickness of 100 nm was formed using a protective layer coating solution obtained by synthesizing the polymer (P-101) using the following reaction scheme and dissolving the synthesized polymer in a solvent.

<Preparation of Protective Layer>

(Synthesis of polymer (P-101))

A polymer (P-101) was synthesized by the following reaction scheme.

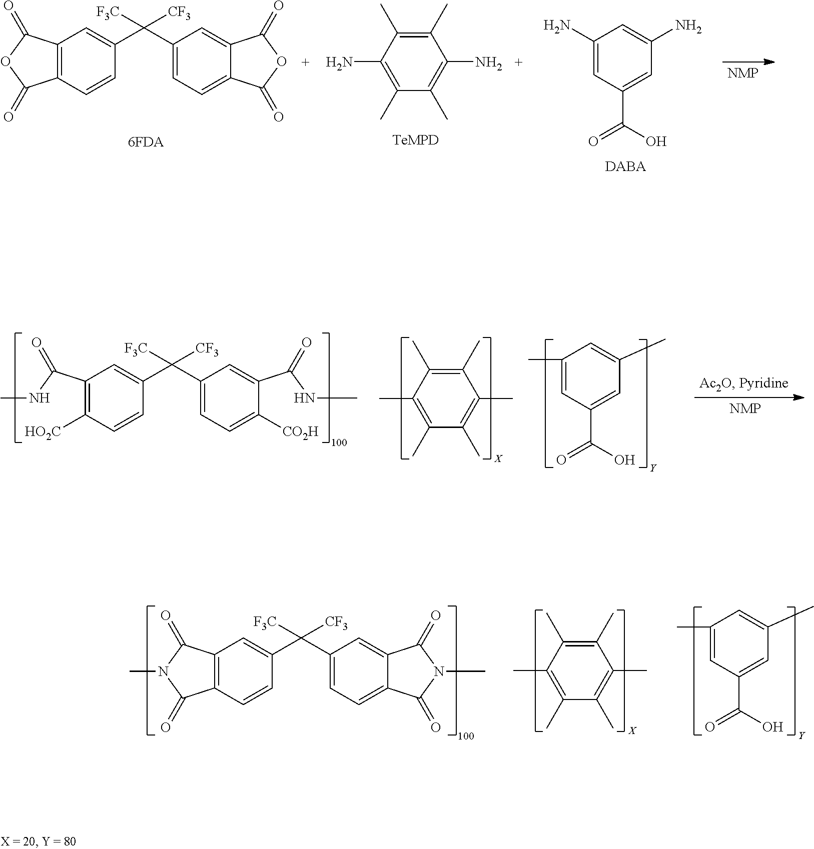

Synthesis of Polymer (P-101)

123 mL of N-methylpyrrolidone and 54.97 g (0.124 mol) of 6FDA (4,4-(hexafluoroisopropylidene, manufactured by Tokyo Chemical Industry Co., Ltd., product number: H0771) were added to a 1 L three-neck flask, dissolved at 40° C., and stirred in a nitrogen stream. A solution obtained by dissolving 4.098 g (0.0248 mol) of 2,3,5,6-tetramethylphenylenediamine (manufactured by Tokyo Chemical Industry Co., Ltd., product number: T1457) and 15.138 g (0.0992 mol) of 3,5-diaminobenzoic acid in 84.0 mL of N-methylpyrrolidone was added dropwise to the above-described solution for 30 minutes while the temperature in the system was maintained at 40° C. After the reaction solution was stirred at 40° C. for 2.5 hours, 2.94 g (0.037 mol) of pyridine (manufactured by Wako Pure Chemical Industries, Ltd.) and 31.58 g (0.31 mol) of acetic anhydride (manufactured by Wako Pure Chemical Industries, Ltd.) were respectively added to the reaction solution, and the solution was further stirred at 80° C. for 3 hours. Subsequently, 676.6 mL of acetone was added to the reaction solution so that the solution was diluted. An acetone diluent of the reaction solution was added dropwise to a solution obtained by adding 1.15 L of methanol and 230 mL of acetone to a 5 L stainless steel container and stirring the mixture. The obtained polymer crystals were suctioned and filtered and then blast dried at 60° C., thereby obtaining 50.5 g of a polymer (P-101). Further, the polymer (P-101) was a polymer in which the ratio of X:Y was set to 20:80 in the polyimide compound P-100 exemplified above.

(Formation of Polyimide-Based Protective Layer)

50 g of the polymer (P-101) and 4.95 kg of ethyl methyl ketone were mixed with each other and stirred at 25° C. for 30 minutes. Thereafter, the stirred solution was formed into a protective layer coating solution.

### Comparative Example 1

In Example 1, the porous support before the protective layer was formed and the separation layer containing a silsesquioxane compound were formed into a gas separation membrane of Comparative Example 1.

[Evaluation]

<Pure Water Contact Angle>

In each gas separation membrane of each example, the pure water contact angle in a case were pure water at 25° C. was dropped on a surface of the protective layer was measured using an automatic contact angle meter DM-501 (manufactured by Kyowa Interface Science Co., Ltd.) according to the following method. 0.5 μL of pure water was dropped on the protective layer side of the gas separation membrane of each example at 25° C., and the contact angle between liquid droplets and the protective layer after 3 seconds from the dropwise addition.

Further, in the gas separation membrane of Comparative Example 1 provided without a protective layer, a pure water contact angle in a case where pure water was dropped on the surface of the separation layer was acquired

The obtained results are listed in Table 2.

<Gas Separation Performance>

The gas separation membranes of the respective examples and the comparative examples as the obtained thin layer composite membranes, were evaluated using a SUS316 STAINLESS STEEL CELL (manufactured by DENIS SEN Ltd.) having high pressure resistance after the temperature of a cell was adjusted to 30° C. The respective gas permeabilities of CO₂ and CH₄ were measured by TCD detection type gas chromatography by adjusting the total pressure on the gas supply side of mixed gas, in which the volume ratio of carbon dioxide (CO₂) to methane (CH₄) was set to 6:94, to 5 MPa (partial pressure of CO₂: 0.65 MPa). The gas separation selectivity of a gas separation membrane of each example and each comparative example was calculated as a ratio (P_{CO2}/P_{CH4}) of the permeability coefficient P_{CO2} of CO₂ to the permeability coefficient P_{CH4} of CH₄ of this membrane. The CO₂ permeability of a gas separation membrane of each example and each comparative example was set as the permeability Q_{CO2} (unit: GPU) of CO₂ of this membrane.

In addition, the unit of gas permeability was expressed by the unit of GPU [1 GPU=1×10⁻⁶ cm³ (STP)/cm²·sec·cmHg] representing the permeation flux (also referred to as permeation rate, permeability, and Permeance) per pressure difference or the unit of barrer [1 barrer=1×10⁻¹⁰ cm³ (STP)·cm/cm²·sec·cmHg] representing the permeability coefficient. In the present specification, the symbol Q is used to represent in a case of the unit of GPU and the symbol P is used in a case of the unit of barrer.

In a case where the gas permeability (permeability Q_{CO2} of CO₂) was 10 GPU or greater and the gas separation selectivity was 30 or greater, the gas separation performance was evaluated as A.

In a case where the gas permeability (permeability Q_{CO2} of CO₂) was 10 GPU or greater and less than 30 GPU and the gas permeability (permeability Q_{CO2} of CO₂) was less than 10 GPU and the gas separation selectivity was 30 or greater, the gas separation performance was evaluated as B.

In a case where the gas permeability (permeability Q_{CO2} of CO₂) was less than 10 GPU and the gas separation selectivity was less than 30 or the pressure was not applied (the pressure was not able to be held) so that the test was not able to be performed, the gas separation performance was evaluated as C.

The obtained results are listed in the following Table 2.

<Rub Resistance>

BEMCOT was placed on the protective layer of the gas separation membrane of each example or the separation layer containing a silsesquioxane compound of the gas separation membrane of Comparative Example 1 so that a load of 20 g was applied, and the gas permeability was measured after movement by 5 cm. The obtained gas permeability was set as the gas permeability after the rub resistance test.

The performance retention rate of the CO₂ gas permeability after the rub resistance test with respect to the initial CO₂ gas permeability acquired in the evaluation of the gas separation performance was calculated. The obtained results were evaluated as the rub resistance based on the following standard. In the evaluation of rub resistance, AA, A, or B is preferable, AA or A is more preferable, and AA is particularly preferable.

AA: a retention rate of 95% or greater

A: a retention rate of less than 95% and 80% or greater

B: a retention rate of less than 80% and 50% or greater

C: a retention rate of less than 50%

The obtained results are listed in Table 2.

<Water Resistance>

The gas permeability was measured after the gas separation membrane of each example was stored in a thermohygrostat bath at a temperature of 50° C. and a relative humidity of 50% for 1 month. The obtained gas permeability was set as the gas permeability after the water resistance test. The performance retention rate of the CO₂ gas permeability after the water resistance test with respect to the initial CO₂ gas permeability acquired in the evaluation of the gas separation performance was calculated. The obtained results were evaluated as the water resistance based on the following standard. In the evaluation of rub resistance, AA, A, or B is preferable, AA or A is more preferable, and AA is particularly preferable.

AA: a retention rate of less than 95% and 80% or greater

A: a retention rate of less than 95% and 80% or greater

B: a retention rate of less than 80% and 50% or greater

C: a retention rate of less than 50%

The obtained results are listed in Table 2.

TABLE 2

| | | Example 1 | Example 2 | Example 3 | Example 4 | Example 5 | Example 6 |
|---|---|---|---|---|---|---|---|
| Separation layer | Composition | Silsesquioxane | Silsesquioxane | Silsesquioxane | Silsesquioxane | Silsesquioxane | Silsesquioxane |
| | Thickness [nm] | 90 | 90 | 90 | 90 | 90 | 90 |
| | O/Si ratio (surface) | 1.85 | 1.85 | 1.85 | 1.85 | 1.85 | 1.85 |
| | O/Si ratio (45 nm) | 1.81 | 1.81 | 1.81 | 1.81 | 1.81 | 1.81 |
| | O/Si ratio (90 nm) | 1.80 | 1.80 | 1.80 | 1.80 | 1.80 | 1.80 |
| | Composition in | Uniform | Uniform | Uniform | Uniform | Uniform | Uniform |
| | thickness direction | | | | | | |
| Protective layer | Composition | PDMS-based | PDMS-based | PDMS-based | PDMS-based | PDMS-based | Q resin- |
| | | | | | | | containing PDMS |
| | Thickness [nm] | 80 | 100 | 1000 | 3200 | 3500 | 1000 |

| | | | | | | |
|---|---|---|---|---|---|---|
| Porous layer on protective layer side | Not available | Not available | Not available | Not available | Not available | Not available |
| Pure water contact angle | 110 degrees | 110 degrees | 110 degrees | 110 degrees | 110 degrees | 90 degrees |
| Gas separation performance | A | A | B | B | B | B |
| Rub resistance | B | A | AA | AA | AA | AA |
| Water resistance | B | A | A | A | A | A |

| | | | | | Comparative |
|---|---|---|---|---|---|
| | | Example 7 | Example 8 | Example 9 | Example 1 |
| Separation layer | Composition | Silsesquioxane | Silsesquioxane | Silsesquioxane | Silsesquioxane |
| | Thickness [nm] | 90 | 90 | 90 | 90 |
| | O/Si ratio (surface) | 1.85 | 1.85 | 1.85 | 1.85 |
| | O/Si ratio (45 nm) | 1.81 | 1.81 | 1.81 | 1.81 |
| | O/Si ratio (90 nm) | 1.80 | 1.80 | 1.80 | 1.80 |
| | Composition in | Uniform | Uniform | Uniform | Uniform |
| | thickness direction | | | | |
| Protective layer | Composition | Q resin- | Cellulose-based | Polyimide-based | Not available |
| | | containing PDMS | | | |
| | Thickness [nm] | 1000 | 100 | 100 | |

| | | | | |
|---|---|---|---|---|
| Porous layer on protective layer side | Available | Not available | Not available | Not available |
| Pure water contact angle | 100 degrees | 40 degrees | 60 degrees | 55 degrees |
| Gas separation performance | B | A | A | A |
| Rub resistance | AA | AA | AA | C |
| Water resistance | A | B | B | C |

As listed in Table 2, it was understood that the gas separation membrane of the present invention includes a separation layer containing a silsesquioxane compound and the rub resistance thereof is excellent.

Meanwhile, it was understood that the rub resistance of the separation layer containing a silsesquioxane compound is poor in a case where a protective layer is not provided, based on Comparative Example 1.

### Examples 101 to 109

Formation of Modules

Spiral type modules were prepared using the gas separation membranes prepared with reference to paragraphs [0012] to [0017] of JP1993-168869A (JP-H05-168869A) using the gas separation membrane prepared in Examples 101 to 109. The obtained gas separation membrane modules were set as the gas separation membrane modules of Examples 101 to 109.

It was confirmed that the prepared gas separation membrane modules of Examples 101 to 109 were excellent based on the performance of the gas separation membranes incorporated therein.

In the prepared gas separation membrane modules of Examples 101 to 109, ten portions having a size of 1 cm×1 cm were randomly collected from the center of one surface of a leaf (leaf indicates a portion of a gas separation membrane in which the space on the permeation side in the spiral type module is connected to the central tube and which is folded into an envelope shape with a size of 10 cm×10 cm) and the element ratios of the surface in the depth direction were calculated according to the method of Example 1, and then the modules were confirmed to have the performance as understood from the separation membranes incorporated therein based on nine or more out of ten portions. It was confirmed that the spiral modules were excellent as the performance of the gas separation membranes incorporated therein.

### EXPLANATION OF REFERENCES

3: separation layer containing silsesquioxane compound
4: support
6: surface of separation layer containing silsesquioxane compound
7: surface of separation layer containing silsesquioxane compound at depth d (in direction of support) from front surface of separation layer containing silsesquioxane compound
8: protective layer
9: porous layer
10: gas separation membrane
d: depth (in direction of support) from front surface of separation layer containing silsesquioxane compound

What is claimed is:

1. A gas separation membrane comprising:
a separation layer which contains a silsesquioxane compound; and
a protective layer,
wherein a composition of the separation layer in a thickness direction is uniform.

2. The gas separation membrane according to claim 1,
wherein a thickness of the protective layer is in a range of 100 to 3500 nm.

3. The gas separation membrane according to claim 1,
wherein a pure water contact angle in a case where pure water at 25° C. is dropped on a surface of the protective layer is 30 degrees or greater.

4. The gas separation membrane according to claim 2,
wherein a pure water contact angle in a case where pure water at 25° C. is dropped on a surface of the protective layer is 30 degrees or greater.

5. The gas separation membrane according to claim 3,
wherein the pure water contact angle in a case where pure water at 25° C. is dropped on the surface of the protective layer is 50 degrees or greater.

6. The gas separation membrane according to claim 4,
wherein the pure water contact angle in a case where pure water at 25° C. is dropped on the surface of the protective layer is 50 degrees or greater.

7. The gas separation membrane according to claim 5,
wherein the pure water contact angle in a case where pure water at 25° C. is dropped on the surface of the protective layer is 90 degrees or greater.

8. The gas separation membrane according to claim 6,
wherein the pure water contact angle in a case where pure water at 25° C. is dropped on the surface of the protective layer is 90 degrees or greater.

9. The gas separation membrane according to claim 1,
wherein the protective layer contains a silicone resin.

10. The gas separation membrane according to claim 1,
wherein the gas separation membrane allows selective permeation of carbon dioxide from mixed gas containing carbon dioxide and gas other than carbon dioxide.

11. The gas separation membrane according to claim 1, further comprising:
a support which is provided on a side of the separation layer opposite to the protective layer.

12. A method of producing a gas separation membrane according to claim 1, comprising:
forming a film by carrying out reaction of the separation layer using a sol-gel method to synthesize the silsesquioxane compound.

13. The method of producing a gas separation membrane according to claim 12,
wherein the reaction carried out using the sol-gel method is initiated or promoted by photo-excitation.

14. A gas separation membrane module comprising:
the gas separation membrane according to claim 1.

15. A gas separator comprising:
the gas separation membrane module according to claim 14.
